(19) United States
(12) Patent Application Publication
(10) Pub. No.: US 2025/0243422 A1
(43) Pub. Date: Jul. 31, 2025

(54) ENHANCED CHARCOAL BRIQUETTES AND METHODS FOR MAKING THE SAME

(71) Applicant: DANIEL CHECK, Conway, SC (US)

(72) Inventor: DANIEL CHECK, Conway, SC (US)

(21) Appl. No.: 18/655,685

(22) Filed: May 6, 2024

Related U.S. Application Data
(60) Provisional application No. 63/625,590, filed on Jan. 26, 2024.

(51) Int. Cl. C10L 5/32; C10L 5/36

(52) U.S. Cl. CPC C10L 5/32; C10L 5/361; C10L 2230/10; C10L 2230/18

(57) ABSTRACT

Described are enhanced charcoal briquettes. Charcoal briquettes are formed from coal dust, a biomass material, sawdust, and/or the like. A combustible coating is disposed about at least part of the charcoal briquette. The combustible coating acts as an initial ignition material during initial lighting of a pile of enhanced charcoal briquettes. The charcoal briquette within the combustible coating acts as a main/primary ignition material. Effective and sustained ignition of the charcoal briquette is aided by the combustion of the initial ignition material at least partially coating/disposed about the charcoal briquette. When enhanced charcoal briquettes are piled together, the combustible coating disposed on and/or about at least part of each charcoal briquette functions as a spacer between adjacent briquettes to increase airflow through the pile of briquettes, leading to more effective secondary ignition of the charcoal briquettes following ignition/combustion of the combustible coating.

### CROSS-REFERENCE TO RELATED APPLICATIONS

This application claims the benefit of priority to U.S. Provisional Patent Application Ser. No. 63/625,590, filed Jan. 26, 2024 and entitled “Enhanced Charcoal Briquettes and Methods for Making the Same,” the entire disclosure of which is hereby incorporated herein by reference in its entirety for all purposes.

### TECHNICAL FIELD

The present disclosure relates, generally to enhanced charcoal briquettes and methods for making the same.

### BACKGROUND

Charcoal briquettes are a solid fuel material often combusted cooking, heating, and other purposes. Charcoal briquettes are typically made from coal, a biomass material, such as sawdust, grass, or wood chips, and/or the like. Briquettes are typically formed by compressing loose combustible material into a denser form, thereby increasing the energy density of the briquettes, and then, optionally, heating the briquettes to reduce moisture content.

Conventional charcoal briquettes, however, typically exhibit a high average combustion temperature of between about 700° C. and about 1,300° C., which refers to the temperature at which the charcoal briquettes undergo effective combustion. High combustion temperatures often result in conventional charcoal briquettes exhibiting ignition issues, meaning that a pile of conventional charcoal briquettes are often difficult to light and require careful tending during initial lighting of a pile of the charcoal briquettes.

### SUMMARY

Described are enhanced charcoal briquettes. Charcoal briquettes are formed from coal dust, a biomass material, sawdust, and/or the like. A combustible coating is disposed about at least part of the charcoal briquette. The combustible coating acts as an initial ignition material during initial lighting of a pile of enhanced charcoal briquettes. The charcoal briquette within the combustible coating acts as a main/primary ignition material. Effective and sustained ignition of the charcoal briquette is aided by the combustion of the initial ignition material at least partially coating/disposed about the charcoal briquette. When enhanced charcoal briquettes are piled together, the combustible coating disposed on and/or about at least part of each charcoal briquette functions as a spacer between adjacent briquettes to increase airflow through the pile of briquettes, leading to more effective secondary ignition of the charcoal briquettes following ignition/combustion of the combustible coating.

According to an embodiment, a method can be carried out that comprises: preparing a solution comprising a combustible material disposed within a liquid solvent; disposing the solution onto at least a portion of an outside surface of a charcoal briquette; and drying the solution/allowing the solution to dry, thereby forming a combustible coating covering at least a portion of the outside surface of the charcoal briquette.

In some embodiments, the charcoal briquette has a first average combustion temperature and a first average energy density, and wherein the combustible coating has a second average combustion temperature less than the first average combustion temperature and a second average energy density less than the first average energy density. In some embodiments, the first average combustion temperature is between about 700° C. and about 1,300° C. In some embodiments, the second average combustion temperature is between about 200° C. and about 250° C. In some embodiments, the first average energy density is between about 20 GJ/tonne lower heating value and about 25 GJ/tonne lower heating value. In some embodiments, the second average energy density is between about 12 GJ/m³ lower heating value and about 18 GJ/m³ lower heating value.

In some embodiments, the combustible coating comprises a paper material. In some embodiments, the charcoal briquette is torrefied or carbonized. In some embodiments, a moisture content of the charcoal briquette is less than about 20 wt. %.

According to another embodiment, a method can be carried out that comprises: providing a sheet of a combustible material; contacting a portion of the sheet of the combustible material to at least a portion of an outer surface of a charcoal briquette; and separating the portion of the sheet of the combustible material from a remainder of the sheet of the combustible material, the portion of the sheet remaining at least partially in contact with at least a portion of the outer surface of the charcoal briquette, thereby forming the enhanced charcoal briquette.

In some embodiments, the charcoal briquette has a first average combustion temperature and a first average energy density, and wherein the combustible coating has a second average combustion temperature less than the first average combustion temperature and a second average energy density less than the first average energy density. In some embodiments, the first average combustion temperature is between about 700° C. and about 1,300° C. In some embodiments, the second average combustion temperature is between about 200° C. and about 250° C. In some embodiments, the first average energy density is between about 20 GJ/tonne lower heating value and about 25 GJ/tonne lower heating value. In some embodiments, the second average energy density is between about 12 GJ/m³ lower heating value and about 18 GJ/m³ lower heating value.

In some embodiments, the combustible coating comprises a paper material. In some embodiments, the charcoal briquette is torrefied or carbonized. In some embodiments, a moisture content of the charcoal briquette is less than about 20 wt. %.

According to another embodiment, an enhanced charcoal briquette can be provided that comprises: a charcoal briquette comprising a mass of densified feedstock material shaped into a briquette having two or more convex surfaces, the charcoal briquette having a first average combustion temperature and a first average energy density; and a combustible coating disposed about at least a portion of the charcoal briquette, the combustible coating having a second average combustion temperature less than the first average combustion temperature and a second average energy density less than the first average energy density.

In some embodiments, the first average combustion temperature is between about 700° C. and about 1,300° C. In some embodiments, the second average combustion temperature is between about 200° C. and about 250° C. In some embodiments, the first average energy density is between about 20 GJ/tonne lower heating value and about 25 GJ/tonne lower heating value. In some embodiments, the second average energy density is between about 12 GJ/m³ lower heating value and about 18 GJ/m³ lower heating value. In some embodiments, the combustible coating comprises a paper material. In some embodiments, the charcoal briquette is torrefied or carbonized. In some embodiments, a moisture content of the charcoal briquette is less than about 20 wt. %. In some embodiments, the charcoal briquette is one of: a charcoal briquette, a pellet, a peat briquette, a biomass briquette, a wood charcoal briquette, a lignite coal briquette, an anthracite coal briquette, a starch briquette, a paper briquette, a sawdust briquette, a wood briquette, a mixed solid waste briquette, a cardboard briquette, a culm bomb, a phurnacite briquette, a quick grill briquette, a ycontan, a mametan, an ogatan, a high calo tan, a tadon, or a shichirin.

According to another embodiment, a method can be carried out that comprises: providing a briquette comprising a biomass material; and disposing a combustible coating about at least a portion of the briquette. In some embodiments, the method can further comprise: heating a mass of loose feedstock in a controlled atmosphere to form a charcoal material; causing the charcoal material to be communicated into an inner volume of a briquetting device; and causing the briquetting device to densify the charcoal material to form the briquette. In some embodiments, the method can further comprise: causing a mass of loose feedstock to be communicated into an inner volume of a briquetting device; causing the briquetting device to densify the mass of loose feedstock to form the briquette; and heating the briquette in a controlled atmosphere to form a charcoal briquette.

In some embodiments, the method can further comprise: applying an adhesive to at least a portion of an inner surface of the combustible coating. In some embodiments, the method can further comprise: mixing a combustible material in a solvent to form a combustible coating solution; and disposing the combustible coating solution onto at least one side of the charcoal briquette. In some embodiments, the method can further comprise: at least partially drying the combustible coating solution disposed onto at least one side of the charcoal briquette to form the combustible coating.

In some embodiments, densifying the mass of biomass feedstock to form the charcoal briquette further comprises: densifying the mass of biomass feedstock to form a green briquette; and torrefying the green briquette to form the charcoal briquette. In some embodiments, the method can further comprise: mechanically separating the mass of biomass feedstock; and drying the mass of biomass feedstock.

According to another embodiment, an apparatus can be provided that comprises: at least one processor; and at least one memory storing instructions thereon that, when executed by the at least one processor, cause the apparatus to perform at least: providing a briquette comprising a biomass material; and disposing a combustible coating about at least a portion of the briquette. In some embodiments, the instructions stored on the at least one memory, when executed by the at least one processor, further cause the apparatus to perform at least: heating a mass of loose feedstock in a controlled atmosphere to form a charcoal material; causing the charcoal material to be communicated into an inner volume of a briquetting device; and causing the briquetting device to densify the charcoal material to form the briquette.

In some embodiments, the instructions stored on the at least one memory, when executed by the at least one processor, further cause the apparatus to perform at least: causing a mass of loose feedstock to be communicated into an inner volume of a briquetting device; causing the briquetting device to densify the mass of loose feedstock to form the briquette; and heating the briquette in a controlled atmosphere to form a charcoal briquette.

In some embodiments, the instructions stored on the at least one memory, when executed by the at least one processor, further cause the apparatus to perform at least: applying an adhesive to at least a portion of an inner surface of the combustible coating. In some embodiments, the instructions stored on the at least one memory, when executed by the at least one processor, further cause the apparatus to perform at least: mixing a combustible material in a solvent to form a combustible coating solution; and disposing the combustible solution onto at least a portion of an outer surface of the charcoal briquette. In some embodiments, the instructions stored on the at least one memory, when executed by the at least one processor, further cause the apparatus to perform at least: at least partially drying the combustible coating solution disposed onto at least a portion of the outer surface of the charcoal briquette to form a combustible coating thereon.

In some embodiments, densifying the mass of biomass feedstock to form the charcoal briquette further comprises: densifying the mass of biomass feedstock to form a green briquette; and torrefying the green briquette to form the charcoal briquette. In some embodiments, the instructions stored on the at least one memory, when executed by the at least one processor, further cause the apparatus to perform at least: mechanically separating the mass of biomass feedstock; and drying the mass of biomass feedstock.

According to another embodiment, an apparatus can be provided that comprises: at least one processor; and at least one memory storing instructions thereon that, when executed by the at least one processor, cause the apparatus to perform at least: preparing a solution comprising a combustible material disposed within a liquid solvent; disposing the solution onto at least a portion of an outside surface of a charcoal briquette; and drying the solution/allowing the solution to dry, thereby forming a combustible coating covering at least a portion of the outside surface of the charcoal briquette.

In some embodiments, the charcoal briquette has a first average combustion temperature and a first average energy density, and wherein the combustible coating has a second average combustion temperature less than the first average combustion temperature and a second average energy density less than the first average energy density. In some embodiments, the first average combustion temperature is between about 700° C. and about 1,300° C. In some embodiments, the second average combustion temperature is between about 200° C. and about 250° C. In some embodiments, the first average energy density is between about 20 GJ/tonne lower heating value and about 25 GJ/tonne lower heating value. In some embodiments, the second average energy density is between about 12 GJ/m³ lower heating value and about 18 GJ/m³ lower heating value.

In some embodiments, the combustible coating comprises a paper material. In some embodiments, the charcoal briquette is torrefied or carbonized. In some embodiments, a moisture content of the charcoal briquette is less than about 20 wt. %.

According to another embodiment, an apparatus can be provided that comprises: at least one processor; and at least one memory storing instructions thereon that, when executed by the at least one processor, cause the apparatus to perform at least: providing a sheet of a combustible material; contacting a portion of the sheet of the combustible material to at least a portion of an outer surface of a charcoal briquette; and separating the portion of the sheet of the combustible material from a remainder of the sheet of the combustible material, the portion of the sheet remaining at least partially in contact with at least a portion of the outer surface of the charcoal briquette, thereby forming the enhanced charcoal briquette.

In some embodiments, the charcoal briquette has a first average combustion temperature and a first average energy density, and wherein the combustible coating has a second average combustion temperature less than the first average combustion temperature and a second average energy density less than the first average energy density.

In some embodiments, the first average combustion temperature is between about 700° C. and about 1,300° C. In some embodiments, the second average combustion temperature is between about 200° C. and about 250° C. In some embodiments, the first average energy density is between about 20 GJ/tonne lower heating value and about 25 GJ/tonne lower heating value. In some embodiments, the second average energy density is between about 12 GJ/m³ lower heating value and about 18 GJ/m³ lower heating value.

In some embodiments, the combustible coating comprises a paper material. In some embodiments, the charcoal briquette is torrefied or carbonized. In some embodiments, a moisture content of the charcoal briquette is less than about 20 wt. %.

In an embodiment, an enhanced charcoal briquette is a composition of matter that comprises a charcoal briquette comprising a mass of densified fuel material shaped into a briquette having two or more convex surfaces, the charcoal briquette having a first average combustion temperature and a first average energy density; and a combustible coating disposed about at least a portion of the charcoal briquette, the combustible coating having a second average combustion temperature less than the first average combustion temperature and a second average energy density less than the first average energy density.

In some embodiments, the first average combustion temperature is between about 700° C. and about 1,300° C. In some embodiments, the second average combustion temperature is between about 200° C. and about 250° C. In some embodiments, the first average energy density is between about 20 GJ/tonne lower heating value and about 25 GJ/tonne lower heating value. In some embodiments, the second average energy density is between about 12 GJ/m³ lower heating value and about 18 GJ/m³ lower heating value. In some embodiments, the combustible coating comprises a paper material. In some embodiments, the charcoal briquette is torrefied. In some embodiments, a moisture content of the charcoal briquette is less than about 20 wt. %. In some embodiments, the charcoal briquette is one of: a charcoal briquette, a pellet, a peat briquette, a biomass briquette, a wood charcoal briquette, a lignite coal briquette, an anthracite coal briquette, a starch briquette, a paper briquette, a sawdust briquette, a wood briquette, a mixed solid waste briquette, a cardboard briquette, a culm bomb, a phurnacite briquette, a quick grill briquette, a ycontan, a mametan, an ogatan, a high calo tan, a tadon, or a shichirin.

In an embodiment, a method of making an enhanced charcoal briquette can be carried out. For example, a method of manufacturing an enhanced charcoal briquette, the method comprising: communicating a mass of biomass feedstock into an inner volume of a briquetting device; densifying the mass of biomass feedstock to form a charcoal briquette; and disposing a combustible coating about at least a portion of the charcoal briquette.

In some embodiments, the method can further comprise: applying an adhesive to at least a portion of an inner surface of the combustible coating. In some embodiments, the method can further comprise: mixing a combustible material in a solvent to form a combustible coating solution; and disposing the combustible coating solution onto at least one side of the charcoal briquette. In some embodiments, the method can further comprise: at least partially drying the combustible coating solution disposed onto at least one side of the charcoal briquette to form the combustible coating.

In some embodiments, densifying the mass of biomass feedstock to form the charcoal briquette further comprises: densifying the mass of biomass feedstock to form a green briquette; and torrefying the green briquette to form the charcoal briquette. In some embodiments, the method can further comprise: mechanically separating the mass of biomass feedstock; and drying the mass of biomass feedstock.

According to another embodiment, a device can be provided that is configured for manufacturing enhanced fuel briquettes, the device comprising: a densification unit configured to receive a mass of loose feedstock material and densify the mass of loose feedstock material into a briquette; an adhesive applicator configured to dispose a volume of an adhesive to at least a portion of an outer surface of the briquette; and a coating applicator configured to dispose a combustible coating material to at least the portion of the outer surface of the briquette to which the adhesive applicator disposed the volume of the adhesive.

According to another embodiment, a charcoal briquette can be provided that comprises: a charcoal core; and a primary combustion/ignition material disposed about a portion of the charcoal core. In some embodiments, the primary combustion/ignition material is applied as a coating on an outer surface of the charcoal core. In some embodiments, the primary combustion/ignition material is interspersed within the charcoal core. In some embodiments, the charcoal briquette can further comprise: a protective layer covering the primary combustion/ignition material. In some embodiments, the protective layer is heat-resistant and prevents premature ignition of the primary combustion/ignition material.

In some embodiments, the primary combustion/ignition material comprises a mixture of at least one accelerant and a binder. In some embodiments, the accelerant is selected from the group consisting of potassium nitrate, sodium nitrate, and charcoal lighter fluid. In some embodiments, the binder is selected from the group consisting of starch, clay, and vegetable oil.

According to another embodiment, a method can be carried out to manufacture a charcoal briquette, the method comprising: providing a charcoal core; and applying a primary combustion/ignition material about at least a portion of the charcoal core. In some embodiments, the method can further comprise: curing the charcoal briquette to enhance the adherence of the primary combustion/ignition material to the charcoal core. In some embodiments, said applying the primary combustion/ignition material comprises spraying, dipping, or coating the charcoal core with the primary combustion/ignition material.

According to another embodiment, a charcoal briquette system can be provided that comprises: a plurality of charcoal briquettes, each briquette comprising: a charcoal core; and a primary combustion/ignition material disposed about a portion of the charcoal core. In some embodiments, the primary combustion/ignition material on each briquette is tailored to provide consistent and controlled ignition characteristics. In some embodiments, the primary combustion/ignition material on each briquette is configured to enable quick and efficient lighting of the charcoal core.

According to another embodiment, a charcoal briquette can be provided that comprises: a charcoal core; and a primary combustion/ignition material applied as a coating on at least a portion of an outer surface of the charcoal core, said primary combustion/ignition material comprising a mixture of an accelerant material and a binder material. In some embodiments, a ratio of the accelerant material to the binder material in the primary combustion/ignition material is optimized to achieve a desired ignition temperature within a range of about 350° C. to about 450° C. In some embodiments, the accelerant material comprises a paper material. In some embodiments, the binder material comprises a starch. In some embodiments, the charcoal briquette can further comprise: an adhesive material disposed between at least a portion of the outer surface of the charcoal core and at least a portion of the primary combustion/ignition material. In some embodiments, the adhesive material comprises one of: a vegetable oil, a starch, a clay, a gelatin, a binder polymer, a polyvinyl alcohol, a polyvinyl acetate, a cellulose-based adhesive, an epoxy, a resin, a glycerol, a pectin, a protein-based adhesive, a casein-containing material, a soy protein-containing material, a modified acrylic material, a silicon-based adhesive, an epoxy resin, or a solvent-based adhesive.

Other embodiments are contemplated, such as described herein and illustrated in accompanying drawings.

### BRIEF DESCRIPTION OF THE DRAWINGS

Having thus described the invention in general terms, reference will now be made to the accompanying drawings. The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 illustrates a charcoal briquette, according to an embodiment of the present disclosure.

FIG. 2 illustrates an enhanced charcoal briquette, according to an embodiment of the present disclosure.

FIG. 3 illustrates a process for manufacturing an enhanced charcoal briquette, according to an embodiment of the present disclosure.

FIG. 4 illustrates an enhanced charcoal briquette sparse stacking scheme, according to embodiments of the present disclosure.

FIG. 5 illustrates a break-away view of the enhanced charcoal briquette sparce stacking scheme illustrated in FIG. 4, according to embodiments of the present disclosure.

FIG. 6 is a cross-sectional view of a portion of an enhanced charcoal briquette, according to an embodiment of the present disclosure.

FIG. 7 is a cross-sectional view of a portion of an enhanced charcoal briquette, according to an embodiment of the present disclosure.

FIG. 8 is a cross-sectional view of a portion of an enhanced charcoal briquette, according to an embodiment of the present disclosure.

FIG. 9 is a cross-sectional view of a portion of an enhanced charcoal briquette, according to an embodiment of the present disclosure.

FIG. 10 is a cross-sectional view of a portion of an enhanced charcoal briquette, according to an embodiment of the present disclosure.

FIG. 11 is a cross-sectional view of a portion of an enhanced charcoal briquette, according to an embodiment of the present disclosure.

FIG. 12 is a cross-sectional view of a portion of an enhanced charcoal briquette, according to an embodiment of the present disclosure.

FIG. 13 illustrates a schematic of an example computing device according to any of the approaches or methods of the present disclosure.

FIG. 14 is a block flow diagram of a method for forming an enhanced charcoal briquette, in accordance with embodiments of the present disclosure.

FIG. 15 is a block flow diagram of a method for forming an enhanced charcoal briquette, in accordance with embodiments of the present disclosure.

FIG. 16 is a block flow diagram of a method for forming an enhanced charcoal briquette, in accordance with embodiments of the present disclosure.

FIG. 17 is a block flow diagram of a method for forming an enhanced charcoal briquette, in accordance with embodiments of the present disclosure.

FIG. 18 is a block flow diagram of a method for forming an enhanced charcoal briquette, in accordance with embodiments of the present disclosure.

FIG. 19 is a block flow diagram of a method for forming an enhanced charcoal briquette, in accordance with embodiments of the present disclosure.

FIG. 20 is a block flow diagram of a method for forming an enhanced charcoal briquette, in accordance with embodiments of the present disclosure.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

Various embodiments of the present disclosure will now be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

As used herein, the terms “instructions,” “file,” “designs,” “data,” “content,” “information,” and similar terms may be used interchangeably, according to some example embodiments of the present invention, to refer to data capable of being transmitted, received, operated on, displayed, and/or stored. Thus, use of any such terms should not be taken to limit the spirit and scope of the disclosure. Further, where a computing device is described herein to receive data from another computing device, it will be appreciated that the data may be received directly from the other computing device or may be received indirectly via one or more computing devices, such as, for example, one or more servers, relays, routers, network access points, base stations, and/or the like.

As used herein, the term “computer-readable medium” refers to any medium configured to participate in providing information to a processor, including instructions for execution. Such a medium may take many forms, including, but not limited to a non-transitory computer-readable storage medium (for example, non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, and infrared waves. Signals include man-made transient variations in amplitude, frequency, phase, polarization, or other physical properties transmitted through the transmission media. Examples of non-transitory computer-readable media include a floppy disk, a flexible disk, hard disk, magnetic tape, any other non-transitory magnetic medium, a compact disc read only memory (CD-ROM), compact disc compact disc-rewritable (CD-RW), digital versatile disc (DVD), Blu-Ray, any other non-transitory optical medium, punch cards, paper tape, optical mark sheets, any other physical medium with patterns of holes or other optically recognizable indicia, a random access memory (RAM), a programmable read only memory (PROM), an erasable programmable read only memory (EPROM), a FLASH-EPROM, any other memory chip or cartridge, a carrier wave, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

As used herein, the term “circuitry” refers to all of the following: (a) hardware-only circuit implementations (such as implementations in only analog and/or digital circuitry); (b) to combinations of circuits and computer program product(s) comprising software (and/or firmware instructions stored on one or more computer readable memories), such as (as applicable): (i) to a combination of processor(s) or (ii) to portions of processor(s)/software (including digital signal processor(s)), software, and memory(ies) that work together to cause an apparatus, such as a mobile phone or server, to perform various functions described herein); and (c) to circuits, such as, for example, a microprocessor(s) or a portion of a microprocessor(s), that require software or firmware for operation, even if the software or firmware is not physically present. This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, other network device, and/or other computing device.

As used herein, the term “computing device” refers to a specialized, centralized device, network, or system, comprising at least a processor and a memory device including computer program code, and configured to provide guidance or direction related to the charge transactions carried out in one or more charging networks.

As used herein, the terms “about,” “substantially,” and “approximately” generally mean plus or minus 10% of the value stated, e.g., about 250 μm would include 225 μm to 275 μm, about 1,000 μm would include 900 μm to 1,100 μm. Any provided value, whether or not it is modified by terms such as “about,” “substantially,” or “approximately,” all refer to and hereby disclose associated values or ranges of values thereabout, as described above.

Before the present materials, articles and/or methods are disclosed and described, it is to be understood that the aspects described below are not limited to specific compounds, synthetic methods, or uses, as such may, of course, vary. It is also to be understood that the terminology used herein is for the purpose of describing particular aspects only and is not intended to be limiting.

In the specification and in the claims that follow, reference will be made to a number of terms that shall be defined to have the following meanings:

It must be noted that, as used in the specification and the appended claims, the singular forms “a,” “an,” and “the” include plural referents unless the context clearly dictates otherwise. Thus, for example, reference to “a solvent” includes mixtures of two or more solvents and the like.

“Optional” or “optionally” means that the subsequently described event or circumstance can or cannot occur, and that the description includes instances where the event or circumstance occurs and instances where it does not. For example, the compositions described herein may optionally contain a bioactive agent, where the bioactive agent may or may not be present.

Throughout this specification, unless the context dictates otherwise, the word “comprise,” or variations such as “comprises” or “comprising,” will be understood to imply the inclusion of a stated element, integer, step, or group of elements, integers, or steps, but not the exclusion of any other element, integer, step, or group of elements, integers, or steps.

As used herein, the term “about” is used to provide flexibility to a numerical range endpoint by providing that a given numerical value may be “a little above” or “a little below” the endpoint without affecting the desired result. For purposes of the present disclosure, “about” refers to a range extending from 10% below the numerical value to 10% above the numerical value. For example, if the numerical value is 10, “about 10” means between 9 and 11 inclusive of the endpoints 9 and 11.

As used herein, the term “admixing” is defined as mixing two or more components together so that there is no chemical reaction or physical interaction. The term “admixing” also includes the chemical reaction or physical interaction between the two or more components.

As used herein, a plurality of items, structural elements, compositional elements, and/or materials may be presented in a common list for convenience. However, these lists should be construed as though each member of the list is individually identified as a separate and unique member. Thus, no individual member of any such list should be construed as a de facto equivalent of any other member of the same list based solely on its presentation in a common group, without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range was explicitly recited. As an example, a numerical range of “about 1” to “about 5” should be interpreted to include not only the explicitly recited values of about 1 to about 5, but also to include individual values and sub-ranges within the indicated range. Thus, included in this numerical range are individual values such as 2, 3, and 4, the sub-ranges such as from 1-3, from 2-4, from 3-5, from about 1-about 3, from 1 to about 3, from about 1 to 3, etc., as well as 1, 2, 3, 4, and 5, individually. The same principle applies to ranges reciting only one numerical value as a minimum or maximum. The ranges should be interpreted as including endpoints (e.g., when a range of “from about 1 to 3” is recited, the range includes both of the endpoints 1 and 3 as well as the values in between). Furthermore, such an interpretation should apply regardless of the breadth or range of the characters being described.

Disclosed are materials and components that can be used for, can be used in conjunction with, can be used in preparation for, or are products of the disclosed compositions and methods. These and other materials are disclosed herein, and it is understood that when combinations, subsets, interactions, groups, etc. of these materials are disclosed, that while specific reference to each various individual combination and permutation of these compounds may not be explicitly disclosed, each is specifically contemplated and described herein. For example, if a hydrogel continuous phase is disclosed and discussed, and a number of different microgels are discussed, each and every combination of hydrogel continuous phase and microgel that is possible is specifically contemplated unless specifically indicated to the contrary. For example, if a class of hydrogel continuous phases A, B, and C are disclosed, as well as a class of microgels D, E, and F, and an example combination of A+D is disclosed, then even if each is not individually recited, each is individually and collectively contemplated. Thus, in this example, each of the combinations A+E, A+F, B+D, B+E, B+F, C+D, C+E, and C+F is specifically contemplated and should be considered from disclosure of A, B, and C; D, E, and F; and the example combination A+D. Likewise, any subset or combination of these is also specifically contemplated and disclosed. Thus, for example, the sub-group of A+E, B+F, and C+E is specifically contemplated and should be considered from disclosure of A, B, and C; D, E, and F; and the example combination of A+D. This concept applies to all aspects of the disclosure including, but not limited to, steps in methods of making and using the disclosed compositions. Thus, if there are a variety of additional steps that can be performed with any specific embodiment or combination of embodiments of the disclosed methods, each such composition is specifically contemplated and should be considered disclosed.

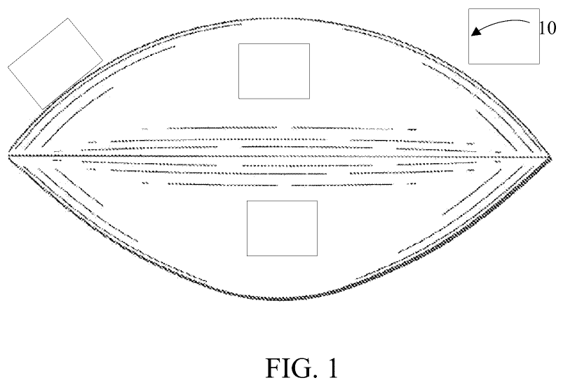

Referring now to FIG. 1, a charcoal briquette 10 is shown. Charcoal briquettes 10 are a solid fuel material often combusted cooking, heating, and other purposes. For example, charcoal briquettes 10 are often combusted within or beneath a grill when cooking. Charcoal briquettes 10 are often stacked/piled in a mounded or conical configuration by pouring a plurality of charcoal briquets 10 from a bag or other container into a combustion space beneath a grill.

Due to the relatively slow ignition time of charcoal briquettes 10, an ignition fluid or accelerant is often before initial lighting of the charcoal briquettes 10. An accelerant such as lighter fluid can be added onto the stack/pile of charcoal briquettes 10 before initial lighting of the charcoal briquettes 10 to aid with initial lighting of the charcoal briquettes 10. The pile of charcoal briquettes 10 can then be ignited using an ignition source, such a lighter or match.

After initial ignition using an ignition source, the accelerant burns quickly and is effectively combusted/consumed quickly, meaning that oftentimes only a small portion of the charcoal briquettes 10 in the stack/pile are actually sufficiently heated by the combustion of the accelerant so as to be ignited/lit themselves. A somewhat prolonged charcoal briquette ignition phase follows in which an outside of the charcoal briquettes 10 at one or more outer edges of the pile/stack are ignited and begin to burn. Over time, combustion migrates from the outside of the charcoal briquettes 10 at the outer edges of the pile/stack towards deeper portions of the same charcoal briquette 10 at the outer edges of the pile/stack. During this initial charcoal briquette ignition phase, a gray ash is formed on a significant portion of the same charcoal briquettes 10 at the outer edges of the stack/pile until a majority of the exposed surfaces of the same charcoal briquettes 10 at the outer edges of the stack/pile have been at least partially ignited.

In order for combustion of the plurality of charcoal briquettes 10 throughout the stack/pile to continue past the initial ash formation phase, a user must spread the charcoal briquettes 10 out under the grill or otherwise reconfigure/rearrange the stack/pile of charcoal briquettes 10. After this, the charcoal briquettes 10 will continue to burn/combust over time. However, during this primary combustion/burn phase, the charcoal briquettes 10 will often reach one or more additional ash formation points where only a portion of the available combustible material has combusted and a remaining portion of the available combustible material will not continue combusting without further intervention, such as by further spreading/rearranging the charcoal briquettes 10 beneath the grill.

For maximum effectiveness and case of use, it is desirable that charcoal briquettes 10 proceed quickly enough through the ignition phase and onto the primary combustion phase so as to reduce the time between initial lighting of the stack/pile of charcoal briquettes 10 and when the stack/pile of charcoal briquettes 10 can be used for cooking/grilling, and to maximize the total cooking/grilling time per unit of available combustible material in the stack/pile of charcoal briquettes 10.

Charcoal briquettes 10 are typically made from coal, a biomass material, such as sawdust, grass, or wood chips, and/or the like. Charcoal briquettes 10 are typically formed by compressing loose combustible material into a denser form, thereby increasing the energy density of the briquettes, and then, optionally, heating the briquettes to reduce moisture content.

Charcoal briquettes 10 are typically formed in a briquetting machine, such as a press. Upon entering the charcoal-making briquette machine, raw feedstock material (such as coal dust, sawdust, biomass, or the like) will be subjected, to some extent, to frictional forces (the forces exerted by each portion of the loose feedstock material on other portions of the loose feedstock material during the briquetting process). Also, shearing forces will be exerted on the feedstock material by the walls of the briquetting machine on loose feedstock material during the briquetting process. However, the primary force acting upon the loose feedstock material during briquetting are compressive forces exerted directly by rollers or presses of the briquetting machine itself.

Charcoal briquettes 10, however, typically exhibit a high average combustion temperature of between about 700° C. and about 1,300° C. This can lead to ignition issues, meaning that charcoal briquettes 10 are often difficult to ignite and require careful tending during initial lighting of a pile of the charcoal briquettes. During ongoing combustion of charcoal briquettes 10, the charcoal briquettes 10 typically exhibit non-optimal combustion characteristics.

Under these and/or other forces, the raw feedstock material will be pressed into a particular shape, such as a briquette shape, bar shape, cylinder shape, or the like. The terms “briquette”, “charcoal briquette”, and “enhanced charcoal briquette” are used throughout the present disclosure interchangeably to refer to any combustible raw feedstock material that is formed, pressed, rolled, or otherwise shaped into any suitable solid fuel material having any suitable form factor. For example, “briquette” as used herein refers to any and all solid fuel materials including, among other compositions, dimensions, and form factors, charcoal briquettes formed from a raw feedstock of dried sawdust compressed into a generally ‘pillow shaped’ briquette (such as the charcoal briquette 10 shown in FIG. 1).

The process of manufacturing charcoal briquettes 10 can be divided into several different sub-processes, including loose feedstock preparation, briquetting of loose feedstock, and carbonization of briquettes. Conversely, the process for manufacturing charcoal briquettes 10 can include loose feedstock preparation, carbonization of loose feedstock, and briquetting of carbonized feedstock.

### Feedstock Preparation

Depending on the feedstock being used, the feedstock preparation can vary. For example, when sawdust is used for forming charcoal briquettes 10, the feedstock preparation process can include chipping, crushing, milling, hammering, macerating, and/or grinding wood or other biomass into raw sawdust.

Raw sawdust will also often have a wide range of particle sizes. With regard to certain processes and certain applications, raw sawdust may include contaminants, ‘fines’ that are undesirably small for the particular application or briquetting machine and process being used, and/or oversized particles that are undesirably large for the particular application or briquetting machine and process being used.

Raw sawdust will often have a variable and undesirably high moisture content (MC), meaning that the sawdust has a low energy density due to the MC. The sawdust can be screened or sieved to achieve a particular particle size distribution or average particle size distribution, such as in a rotary screen, vibratory screening process, or the like. A drum dryer or the like can be used to dry the sawdust down to a particular MC, measured as, e.g., a maximum MC or a mean MC. For example, sawdust feedstock can be dried to achieve a median MC of between ‘bone dry’ (about 0.0 wt. % moisture) and about 20 wt. % moisture.

### Briquetting

The dried sawdust feedstock can be fed into a briquetting machine and pressed into the briquette shape, thereby forming a pressed briquette. Different briquetting machines are used for making charcoal briquettes 10 having different compositions, dimensions, and/or form factors. For example, a briquetting machine may include two rollers positioned such that an outside circumferential surface of one roller is facing an outside circumferential surface of the other roller—the two rollers can be in contact with one another along some or all of the outside circumferential surfaces or a non-zero gap distance can be maintained therebetween. One or both of the outside circumferential surfaces of the rollers can have a plurality of concavities formed therein such that feedstock material accumulates in the concavities.

After feedstock material is disposed within at least a portion of the concavities, one or both of the rollers can then be rotated to apply compressive force to the feedstock material in or about the concavities, thereby forming raw briquettes from the feedstock material. In some embodiments, a binding agent or the like can be mixed with the feedstock material and can facilitate or improve adhesion of feedstock material during and after raw briquette formation. In some embodiments, a briquetting pressure of between about 25 MPa and about 30 MPa can be used to form the briquettes. Other briquetting processes can also or alternatively be used, such as pressing, pelletizing, or the like.

The briquetting process can be a batch-wise process, a semi-continuous process, a fully continuous process, or any combination thereof. For example, in instances in which loose feedstock is carbonized to form loose charcoal before the loose charcoal is briquetted to form the charcoal briquette 10, the loose charcoal, starch binder, and/or other materials can be mixed (such as with a paddle mixer or the like) and maintained at an MC of about 35 wt. %. The blended material can then be pressed (e.g., between two opposing rollers having concavities therein, each concavity being dimensioned and configured to inversely define about ½ of the dimensions and form factor of the charcoal briquette 10. After pressing the two halves of the mixed material together to form the charcoal briquette 10, the charcoal briquette 10 can drop from one or both rollers as the opposing rollers continue to rotate and can land on a conveyor or the like.

The charcoal briquettes 10 may at this point have an MC of between about 25° wt. % and about 35° wt. %. The charcoal briquettes 10 can be conveyed through a dryer, e.g., a single-pass dryer, that heats the charcoal briquettes 10 to between about 100° C. and about 150° C. for a duration of between about 1 hour and about 5 hours to reduce the MC to between about 3 wt. % and about 10 wt. %.

For example, the dryer can operate at a temperature of between about 100° C. and about 500° C., between about 150° C. and about 450° C., between about 200° C. and about 400° C., between about 250° C. and about 350° C., between about 100° C. and about 450° C., between about 100° C. and about 400° C., between about 100° C. and about 300° C., between about 100° C. and about 200° C., between about 200° C. and about 500° C., between about 300° C. and about 500° C., between about 400° C. and about 500° C., less than about 500° C., less than about 400° C., less than about 300° C., less than about 200° C., less than about 100° C., greater than about 100° C., greater than about 200° C., greater than about 300° C., greater than about 400° C., or greater than about 500° C., inclusive of all values and ranges therebetween.

The dryer can operate for a duration of between about 1 hour and about 10 hours, between about 1 hour and about 9 hours, between about 1 hour and about 8 hours, between about 1 hour and about 7 hours, between about 1 hour and about 6 hours, between about 1 hour and about 5 hours, between about 1 hour and about 4 hours, between about 1 hour and about 3 hours, between about 1 hour and about 2 hours, between about 2 hours and about 10 hours, between about 3 hours and about 10 hours, between about 4 hours and about 10 hours, between about 5 hours and about 10 hours, between about 6 hours and about 10 hours, between about 7 hours and about 10 hours, between about 8 hours and about 10 hours, between about 9 hours and about 10 hours, greater than about 1 hour, greater than about 2 hours, greater than about 3 hours, greater than about 4 hours, greater than about 5 hours, greater than about 6 hours, greater than about 7 hours, greater than about 8 hours, greater than about 9 hours, greater than about 10 hours, less than about 10 hours, less than about 9 hours, less than about 8 hours, less than about 7 hours, less than about 6 hours, less than about 6 hours, less than about 5 hours, less than about 4 hours, less than about 3 hours, less than about 2 hours, or less than one hour, inclusive of all values and ranges therebetween.

The dryer can operate at a temperature/temperatures for a duration that is sufficient to reduce the MC of the charcoal briquette 10 to between about 1 wt. % and about 50 wt. %, between about 1 wt. % and about 45 wt. %, between about 1 wt. % and about 40 wt. %, between about 1 wt. % about 1 wt. % and about 30 wt. %, between about 1 wt. % and about 25 wt. %, between about 1 wt. % and about 20 wt. %, between about 1 wt. % and about 15 wt. %, between about 1 wt. % and about 10 wt. %, between about 1 wt. % and about 5 wt. %, between about 3 wt. % and about 50 wt. %, between about 3 wt. % and about 40 wt. %, between about 3 wt. % and about 30 wt. %, between about 3 wt. % and about 20 wt. %, between about 3 wt. % and about 10 wt. %, between about 5 wt. % and about 20 wt. %, between about 5 wt. % and about 15 wt. %, between about 5 wt. % and about 10 wt. %, greater than about 1 wt. %, greater than about 3 wt. %, greater than about 5 wt. %, greater than about 10 wt. %, greater than about 15 wt. %, greater than about 20 wt. %, greater than about 25 wt. %, greater than about 30 wt. %, greater than about 35 wt. %, greater than about 40 wt. %, greater than about 45 wt. %, greater than about 50 wt. %, less than about 50 wt. %, less than about 45 wt. %, less than about 40 wt. %, less than about 35 wt. %, less than about 30 wt. %, less than about 25 wt. %, less than about 20 wt. %, less than about 20 wt. %, less than about 15 wt. %, less than about 10 wt. %, less than about 5 wt. %, less than about 3 wt. %, or less than about 1 wt. %, inclusive of all values and ranges therebetween.

### Carbonization

The raw feedstock or the pressed briquette can be carbonized, torrefied, kilned, charred, or otherwise thermally treated to convert the feedstock into charcoal or to convert the pressed briquette into the charcoal briquette 10. In some embodiments, the carbonization process is carried out on loose feedstock material to create loose charcoal which is then briquetted to form the charcoal briquette 10. In some embodiments, the loose feedstock is briquetted into a briquette and the carbonization process is carried out on the pressed briquette to form the charcoal briquette 10.

For example, carbonization can be carried out in a charcoal carbonization furnace or kiln, by heating pressed briquettes to a temperature of between about 250° C. and about 1,750° C., between about 500° C. and about 1,500° C., between about 750° C. and about 1,200° C., between about 250° C. and about 1,000° C., between about 500° C. and about 1,000° C., between about 250° C. and about 1,200° C., between about 250° C. and about 1,500° C., between about 750° C. and about 1,750° C., between about 500° C. and about 1,500° C., between about 500° C. and about 1,750° C., between about 500° C. and about 750° C., between about 250° C. and about 750° C., between about 250° C. and about 500° C., greater than about 200° C., greater than about 500° C., greater than about 750° C., greater than about 1,000° C., greater than about 1,200° C., greater than about 1,500° C., greater than about 1,750° C., less than about 1,750° C., less than about 1,500° C., less than about 1,250° C., inclusive of all values and ranges therebetween. Such an elevated temperature can be maintained for a period of time, such as between about 1 hour and about 250 hours, between about 24 hours and about 250 hours, between about 48 hours and about 250 hours, between about 72 hours and about 250 hours, between about 1 hour and about 200 hours, between about 1 hour and about 150 hours, or between about 1 hour and about 100 hours, between about 24 hours and about 150 hours, less than about 250 hours, less than about 200 hours, less than about 150 hours, less than about 100 hours, less than about 72 hours, less than about 48 hours, less than about 24 hours, greater than about 24 hours, greater than about 48 hours, greater than about 72 hours, greater than about 100 hours, greater than about 150 hours, greater than about 200 hours, or greater than about 250 hours, inclusive of all values and ranges therebetween. Air flow (oxygen exposure) to pressed briquettes can be controlled (e.g., limited) during certain periods of the carbonization process to optimize reduction of moisture content and to optimize destructive distillation of the biomass material in the pressed briquettes from a chemical and structural perspective. After torrefaction or carbonization or another similar process, the pressed briquettes are converted into the charcoal briquettes 10.

Among other factors or characteristics that can be used to describe the charcoal briquettes 10, several characteristics include: a density, a moisture content, an ash content, a volatile matter concentration, a fixed carbon concentration, a heating value or energy density, an ignition time, and a flame rate. These characteristics can vary depending on feedstock material used for forming the charcoal briquette 10, fillers or other materials added, form factor and dimensions of the charcoal briquette 10, drying steps used, carbonization or torrefaction processes used, and/or other variables. Table 1 provides an example composition and materials characterization information for a charcoal briquette 10 formed from hardwood sawdust, briquetted into a generally pillow-like form factor, and carbonized at about 1,100° C. for about 100 hours.

TABLE 1

| Measure | Units | Charcoal Briquette |
|---|---|---|
| Fixed Carbon | wt. % | 65-90 |
| Oxygen | wt. % | <0.5 |
| Sulfur | wt. % | <0.5 |
| Nitrogen | wt. % | <0.5 |
| Hydrogen | wt. % | <0.5-3 |
| Volatiles | wt. % | 10-20 |
| Ash | wt. % | 2-8 |
| MC | wt. % | 3-10 |
| Density | tonne/m³ | 1.0-2.0 |
| Energy Density | MJ/kg | 15-25 |
| Ignition Time | min | 5-15 |
| Flame/Combustion Rate | g/min | 0.1-2.8 |

Other compositions, densities, energy densities, ignition times, and flame/combustion rates were observed based on changes in the feedstock materials, additives/binding agents, briquette form factors and sizes, manufacturing processes, and other variables.

While the charcoal briquettes 10 produced via the described processes of feedstock preparation, briquetting, and carbonization, in that or a different order, have a relatively high energy density, the charcoal briquettes 10 themselves have an undesirably high ignition temperature and, when in a pile for combustion, exhibit poor oxygen channeling and a drastic combustion temperature gradient through a pile of the charcoal briquettes 10.

During use in any suitable combustion application, such as for cooking, heating, or otherwise, charcoal briquettes 10 are typically piled into a combustion space, such as within a grill or furnace, and the pile of charcoal briquettes 10 are ignited and allowed to begin combusting. The energy density of each charcoal briquette 10, as well as the variable and oftentimes low oxygen channeling through the pile of charcoal briquettes 10 often means that the pile of charcoal briquettes 10 undergoes a practically complete combustion over a relatively long period of time while giving off a high and consistent amount of heat during combustion. This, along with other factors such as high flash point and ignition temperature, make charcoal briquettes 10 a safe and reliable energy source for cooking, heating, and other fuel combustion applications.

However, the high flash point and ignition temperature makes charcoal briquettes 10 (both discretely and in a pile) relatively difficult to light. One way of overcoming the difficulty of lighting a pile of fresh charcoal briquettes 10 is to pile charcoal briquettes 10 within the combustion space and then add a primary ignition/combustion material such as paper onto the pile of charcoal briquettes 10, ignite the primary ignition/combustion material, and allow the primary ignition/combustion material to subsequently ignite the pile of fresh charcoal briquettes 10. However, the primary ignition/combustion material, when disposed on top of a pile of charcoal briquettes 10, will at best merely facilitate ignition of charcoal briquettes 10 immediately beneath the primary ignition/combustion material. In many instances, a primary ignition/combustion material such as paper, when ignited atop a pile of charcoal briquettes 10, will burn too quickly and at too low of a temperature to even ignite charcoal briquettes 10 on the outside or top of the pile of charcoal briquettes 10.

Additionally or alternatively, discrete portions of a primary ignition/combustion material, such as paper or the like, can be mixed with a plurality of charcoal briquettes 10 prior to forming the pile of charcoal briquettes 10. However, this undesirably takes time and energy on the part of a user to form the discrete portions of the primary ignition/combustion material, mix the discrete portions of the primary ignition/combustion material in with the charcoal briquettes 10, and then form the pile of the mixture of the primary ignition/combustion material and charcoal briquettes 10. Because of the difficulty of mixing materials that have different densities, masses, and form factors, and because it is impossible for a user to determine when a homogenous mixture of the primary ignition/combustion material and charcoal briquettes 10 is reached (or because a user will naturally stop mixing the materials together long before homogeneity of the mixture is reached), the end result will be a heterogenous mixture of the primary ignition/combustion material and charcoal briquettes 10. Also, such mixing of the primary ignition/combustion material with the charcoal briquettes 10 typically causes damage to charcoal briquettes 10 and causes charcoal particles from the charcoal briquettes 10 to coat much of the primary ignition/combustion material, thereby increasing the combustion temperature of the primary ignition/combustion material, which is counter to the primary reason for adding the primary ignition/combustion material to the pile of charcoal briquettes 10 in the first place (to improve ignition of the pile of charcoal briquettes 10).

Additionally or alternatively, a liquid fuel source such as lighter fluid can be sprayed onto the pile of charcoal briquettes 10 and the liquid fuel source can also or alternatively be ignited to aid in ignition of the pile of charcoal briquettes 10. However, lighter fluid and other liquid fuel sources are inherently dangerous to use and store, and adding chemicals such as lighter fluid to a solid cooking fuel is often undesirable due to the exposure of food to the chemicals while the food is being cooked over the combusting pile of charcoal briquettes 10.

It is also undesirable that a user must spend time and energy adding other primary ignition/combustion sources onto a pile of charcoal briquettes 10 prior to ignition in order for the pile of charcoal briquettes 10 to ignite properly.

Also, low oxygen channeling/distribution through a pile of charcoal briquettes 10 can lead to burnout or undesirably low combustion temperatures when combusting the pile of charcoal briquettes 10. To reduce this, users may stoke or rearrange the pile of charcoal briquettes 10 during combustion to move hotter combusting charcoal briquettes 10 from an outer layer of the pile to inside the pile and moving cooler combusting or non-combusting charcoal briquettes 10 from inside the pile to the outer layer of the pile, which may cause the hotter combusting charcoal briquettes 10 to cause initial ignition or increase combustion rate/temperature for cooler combusting or non-combusting charcoal briquettes 10 which are now at the outer layer of the pile and exposed to more oxygen, which helps improve the rate and temperature of combustion. However, stoking or rearranging the pile of charcoal briquettes 10 during combustion is inherently dangerous for users who must reach into the combustion space and spend time manually stoking or rearranging the pile of charcoal briquettes 10 during combustion.

Also, stoking or rearranging the pile of charcoal briquettes 10 during combustion often leads to moderate or severe damage to charcoal briquettes 10, especially those which are partially combusted. Partially combusted charcoal briquettes 10 can fracture or crumble due to the partial internal combustion of a charcoal briquette 10, which can produce empty channels/spaces within the charcoal briquette 10 as charcoal material is combusted and converted to thermal energy, light energy, and gases. The empty channels/spaces in partially combusted charcoal briquettes 10 can reduce or eliminate internal mechanical durability, increase friability, and lead to structural failure of the charcoal briquette 10. Stoking or rearranging a pile of charcoal briquettes 10 during combustion can therefore lead to portions of charcoal briquettes 10 breaking off or crumbling, and subsequently being lost within non-combustible ash beneath the pile or tumbling off the pile and out of the combustion space.

It is also undesirable that a user must spend time and energy stoking or rearranging the pile of charcoal briquettes 10 during combustion in order for the pile of charcoal briquettes 10 to combust properly.

Due to the poor initial ignition characteristics and heterogeneity of combustion of charcoal briquettes 10 in a pile, there is a need for enhanced charcoal briquettes that, e.g., when in a pile, are easier to light, without requiring the use of a primary ignition/combustion material such as lighter fluid, and which exhibit more homogeneous combustion characteristics, without requiring that a user stoke or rearrange the charcoal briquettes 10 during combustion.

### Enhancement/Coating of Charcoal Briquettes

Whether the loose feedstock is carbonized/torrefied first and then briquetted or the loose feedstock is briquetted and then carbonized/torrefied, the resulting charcoal briquettes 10 can be further enhanced according to a variety of processes and using a variety of materials, such as described below.

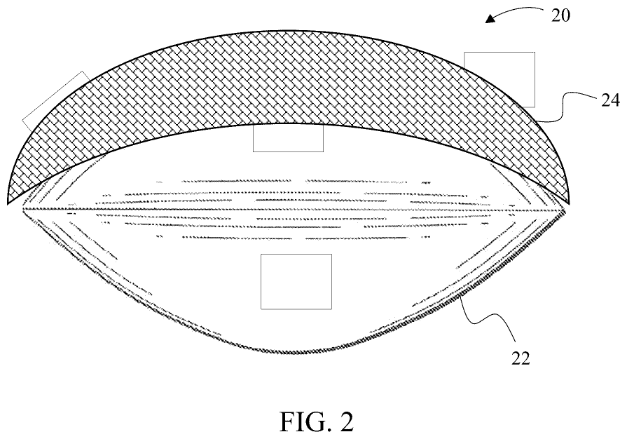

FIG. 2 illustrates an enhanced charcoal briquette 20 according to an embodiment of the present disclosure. In some embodiments, a charcoal briquette 10 can be enhanced by applying a primary ignition/combustion material onto or about a part of the charcoal briquette 10. For example, the enhanced charcoal briquette 20 can comprise a charcoal briquette 22 and a primary ignition/combustion material 24. The charcoal briquette 22 can be similar to or the same as the charcoal briquette 10. As shown, the charcoal briquette 22 has a pillow-like form factor, however other form factors and dimensions are contemplated.

In some embodiments, a slurry (e.g., paper suspended in water or another solvent) can be prepared and sprayed onto the charcoal briquette 22, then allowed to dry, leading to the formation of the primary ignition/combustion material 24 about at least a portion of the charcoal briquette 22, thereby forming the enhanced charcoal briquette 20. In some embodiments, the primary ignition/combustion material 24 can be formed from or comprise a prepared sheet of material that is supplied continuously or on demand. The primary ignition/combustion material 24 can be applied to an outer surface or a portion of the outer surface of the charcoal briquette 22, or the charcoal briquette 22 can be disposed (e.g., dropped) onto the sheet of the primary ignition/combustion material 24 in order to affect application of the primary ignition/combustion material 24 to the outer surface or a portion of the outer surface of the charcoal briquette 22, thereby forming the enhanced charcoal briquette 20.

The primary ignition/combustion material 24 can comprise any suitable material, such as a paper, a cardboard, a textile, a fabric, a nonwoven material, a tissue, a sheet, a parchment, a wood, a vencer, a laminate, and/or the like.

The primary ignition/combustion material 24 can comprise cellulose fibers, hemicellulose fibers, lignin, filler materials, loading materials, calcium carbonate, starches, pigments, sizing agents, and/or the like. The primary ignition/combustion material 24 can comprise greater than about 90 wt. % cellulose and/or hemicellulose fibers. The primary ignition/combustion material 24 can comprise clay, calcium carbonate, talc, titanium oxide, and/or the like. The primary ignition/combustion material 24 can comprise rosin, alum, or other hydrophobic materials. The primary ignition/combustion material 24 can have an MC of between about 1 wt. % and about 30 wt. %, between about 1 wt. % and about 25 wt. %, between about 1 wt. % and about 20 wt. %, between about 1 wt. % and about 15 wt. %, between about 1 wt. % and about 10 wt. %, between about 5 wt. % and about 30 wt. %, between about 10 wt. % and about 30 wt. %, between about 15 wt. % and about 30 wt. %, between about 20 wt. % and about 30 wt. %, between about 25 wt. % and about 30 wt. %, less than about 30 wt. %, less than about 25 wt. %, less than about 20 wt. %, less than about 15 wt. %, less than about 10 wt. %, or less than about 5 wt. %, inclusive of all values and ranges therebetween.

The primary ignition/combustion material 24 can comprise any suitable material that has a sufficient flammability, a sufficient ignitability, a sufficient combustibility, a sufficiently low ignition temperature, a sufficiently high combustion temperature, a sufficiently high energy density, a sufficiently low flash point, or a combination of any of these.

In some embodiments, the primary ignition/combustion material 24 can be disposed onto one or more surfaces or sides of the charcoal briquette 22. In some embodiments, at least a portion of the primary ignition/combustion material 24 can be applied as a coating, a wrapping, a sheath, a jacket, or the like about at least a portion of the charcoal briquette 22. In other embodiments, at least a portion of the charcoal briquette 22 can be disposed onto and/or coupled to at least a portion of the primary ignition/combustion material 24. As used herein, the terms ‘coating’, ‘wrapping’, ‘sheath’, ‘primary ignition material’, and ‘primary combustion material’ are used interchangeably to refer to any ignitable/combustible material used to enhance the ignition and/or combustion characteristics of a charcoal briquette or the like.

In some embodiments, an adhesive or the like can be used to maintain the primary ignition/combustion material 24 on or about at least a portion of the charcoal briquette 22. In some embodiments, an adhesive can be applied to at least a portion of a surface of the primary ignition/combustion material 24 and/or at least a portion of a surface of the charcoal briquette 22. In some embodiments, an adhesive material can be applied to select portions of the primary ignition/combustion material 24 such that only portions of the primary ignition/combustion material 24 are adhered to the surface of the charcoal briquette 22, while other portions of the primary ignition/combustion material 24 are allowed to stand proud of the surface of the charcoal briquette 22. In some embodiments, the adhesive can be water-based, can be selected based on a lack of undesirable ingredients, and/or can be selected based on combustion emission characteristics of the adhesive. In some embodiments, a food-grade adhesive material can be chosen such that when the enhanced charcoal briquette 20 is combusted for cooking purposes, the combustion results in reduced emissions of undesirable or harmful gases or materials as compared to the combustion of an equal quantity of an alternative non-food-grade adhesive under the same combustion parameters.

When the primary ignition/combustion material 24 dries, it can remain chemical and/or physically adhered to the surface of the charcoal briquette 22. When the primary ignition/combustion material 24 dries, portions of the primary ignition/combustion material 24 may lift from the surface of the charcoal briquette 22 while other portions of the primary ignition/combustion material 24 remain adhered to the surface of the charcoal briquette 22.

In some embodiments, a surface of the charcoal briquette 22 and/or a surface of the primary ignition/combustion material 24 can be at least partially wetted such that the primary ignition/combustion material 24 adheres to the surface of the charcoal briquette 22. In some embodiments, the primary ignition/combustion material 24 can be wetted and applied to a non-wetted surface of the charcoal briquette 22. Subsequently, a separate or in-line drying step can be carried out, which causes evaporation of at least part of the moisture content from the wetted primary ignition/combustion material 24. When the primary ignition/combustion material 24 dries, it can remain chemical and/or physically adhered to the surface of the charcoal briquette 22. When the primary ignition/combustion material 24 dries, portions of the primary ignition/combustion material 24 may lift away from (stand proud of) the surface of the charcoal briquette 22 while other portions of the primary ignition/combustion material 24 remain adhered to the surface of the charcoal briquette 22.

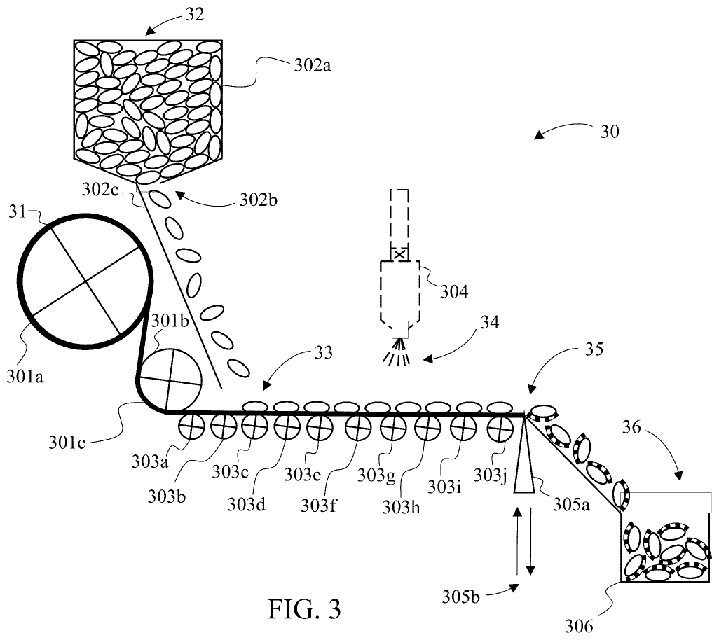

FIG. 3 illustrates a process 30 for forming enhanced charcoal briquettes, such as 20. The process can include a supply of a primary ignition/combustion material 31, which can be disposed about a primary roller 301a or otherwise configured to be dispensed continuously or on demand. A second roller 301b or the like can be provided to cause tension on the primary ignition/combustion material 31, forming a tensioned sheet 301c of the primary ignition/combustion material 31. The process 30 can further include a supply of charcoal briquettes 32, such as 10 or 22. As shown in FIG. 3, the charcoal briquettes 32 can be dispensed from a hopper 302a, via a dispensing aperture 302b, and conveyed using a conveyor 302c, or another suitable approach or device for conveying the charcoal briquettes 32 from the hopper 302a.

The process 30 can further comprise coating 33 one or more surfaces of the charcoal briquettes 32 with the primary ignition/combustion material 31, such as by dropping or otherwise dispensing the charcoal briquettes 32 onto the tensioned sheet 301c of the primary ignition/combustion material 31 as it travels across a conveyor, such as a conveyor illustrated in FIG. 3 by 303a-303j.

As illustrated in FIG. 3, the coating 33 can be carried out by dispensing charcoal briquettes 32 onto a portion of the tensioned sheet 301c of the primary ignition/combustion material 31 as it is dispensed from the primary roller 301a. The dispensed charcoal briquettes 32 can drop from the hopper 302a, into a chute or onto the conveyor 302c, and then drops from a predetermined height onto the primary ignition/combustion material 31 as it travels along the conveyor illustrated using 303a-303j.

Optionally, the process 30 can include adhering 34 the primary ignition/combustion material 31 to one or more surfaces of each charcoal briquette 32. This can be accomplished by applying an adhesive to a top surface of the primary ignition/combustion material 31 between the primary roller 301a, or the other/tensioning roller 301b, and the adhering 34. Alternatively, the adhesive can be already applied to the primary ignition/combustion material 31 before being provided as the primary ignition/combustion material supply 31. Alternatively, the adhesive can be applied to one or more sides or surfaces of the charcoal briquettes 31 after being dispensed from the hopper 302a, at the dispensing aperture 302b, during conveyance along the conveyor 302c, or as the charcoal briquettes 31 travel along the conveyor illustrated as 303a-303j in FIG. 3. The adhesive may take some time to activate and adhere the primary ignition/combustion material 31 to the surface(s) of the charcoal briquettes 32, or vice versa. Alternatively, the adhesive may be chemically, thermally, or otherwise activated during the adhering 34. In embodiments in which the primary ignition/combustion material 31 or the surface of the charcoal briquette 32 is wetted, this can be carried out at the adhering 34. Optionally, in some embodiments, the adhering 34 can be carried out using an adhesive dispensing nozzle 304. Alternatively, in some embodiments, the adhering 34 can be aided or carried out using a heater, dryer, wetting device, and/or the like.

Additionally or alternatively, the charcoal briquettes 32 can be directly disposed upon, joined with, adhered to, thermally adhered to, or otherwise coupled to the primary ignition/combustion material 31, or vice versa. For example, when the charcoal briquettes 32 are formed via compression, the outside of the charcoal briquettes 32 can be hot such that when the The process 30 can further include separation 35 of the discrete charcoal briquettes once disposed on (or adhered 34 to) the primary ignition/combustion material 31. The separation 35 can be carried out by mechanically separating/cutting (e.g., using a cutting edge 305a configured to reciprocate 305b in a direction perpendicular to the tensioned sheet 301c of the primary ignition/combustion material 31) at one or more points about each discrete charcoal briquettes 32 adhered thereto. Alternatively, the separation 35 can be carried out by physically separating each discrete charcoal briquette 32 from the others and allowing for incidental separation of the portion of the primary ignition/combustion material 31 adhered thereto.

In some embodiments, after separation 35, the charcoal briquettes can be dried 36 to form enhanced charcoal briquettes (e.g., 20). Drying can be carried out by a single pass-through dryer. Drying can also be accomplished by loosely storing or packing the enhanced charcoal briquettes (e.g., in a drying vessel 306) prior to separation of portions of the enhanced charcoal briquettes for a product packaging process.

In some embodiments, a coating of primary ignition/combustion material 31 can be formed by mixing a combustible material in a solvent to form a combustible coating solution and then disposing the combustible coating solution onto at least one side of the charcoal briquette 32. Alternatively, the charcoal briquette 32 can be dipped into or partially into a bath of the combustible coating solution.

The combustible coating solution may then be dried. Upon drying, the coating solution becomes a coating of the primary ignition/combustion material 31 formed on at least a portion of an outer surface of the charcoal briquette 32. Before or during drying, the primary ignition/combustion material 31 can adhere to portions of the surface of the charcoal briquette 32. During drying, the primary ignition/combustion material 31 can expand away from the charcoal briquette 32 in places. In some embodiments, the thickness of the coating of the primary ignition/combustion material 31 can be controlled by a volume of combustible coating solution applied to the charcoal briquette 32 and/or a number of layers of the combustible coating solution applied and/or a composition of the combustible coating solution.

While FIG. 3 illustrates the process 30 in which the combustible coating is applied onto an outer surface of the charcoal briquette 32, other processes and approaches are contemplated, and other embodiments of enhanced charcoal briquette (e.g., 20) are also contemplated. For example, an alternative process is contemplated which includes disposing a primary combustion material into portions of the charcoal briquettes 32. An alternative process is also contemplated which includes disposing a primary combustion material between two halves of each charcoal briquette 32 during formation of the charcoal briquette 32 by the briquetting machine.

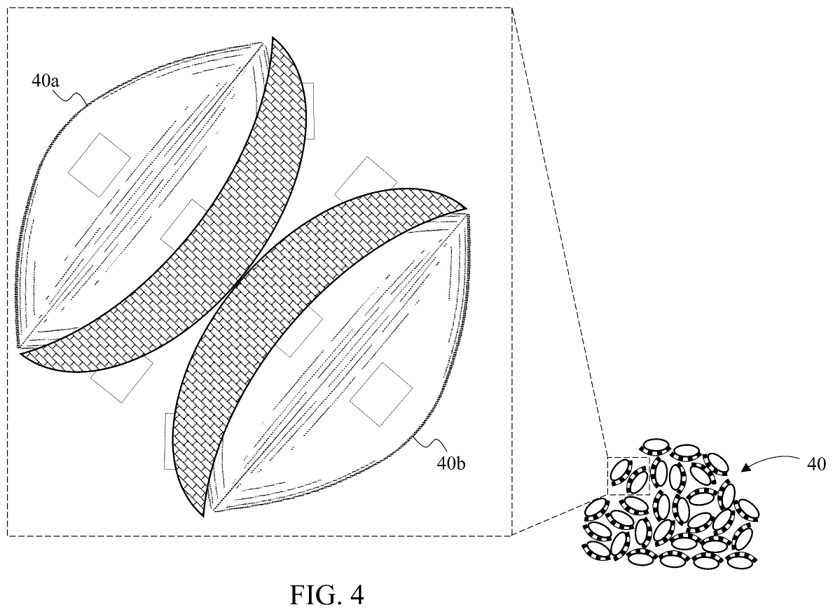

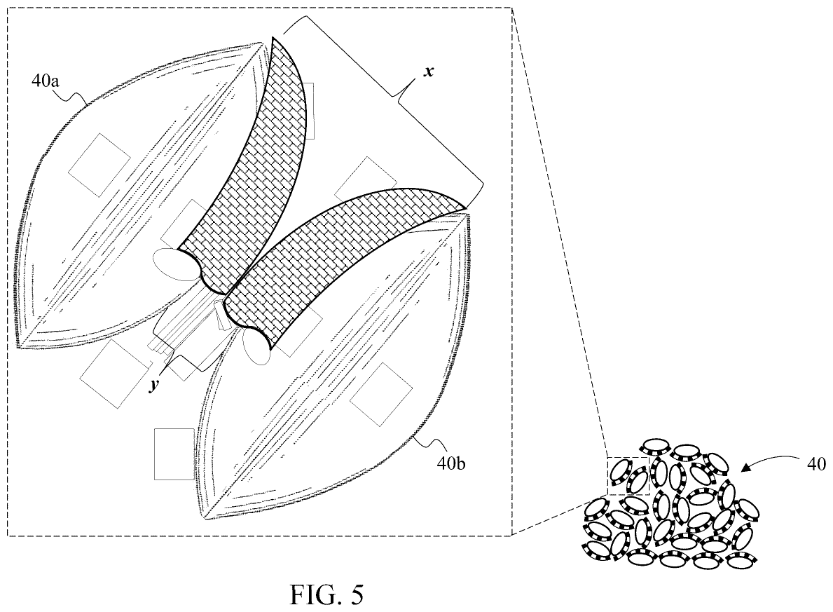

Referring now to FIGS. 4 and 5, an enhanced charcoal briquette pile 40 of enhanced charcoal briquettes (e.g., 20) is illustrated. In some embodiments, the briquettes in the enhanced charcoal briquette pile 40 can be similar to or the same as the enhanced charcoal briquette 20 described above. As shown in the cutout (dash-lined box) of FIG. 4, a first enhanced charcoal briquette 40a and a second enhanced charcoal briquette 40b are shown. As shown, the first and second enhanced charcoal briquettes 40a, 40b each comprise a charcoal briquette and a coating of a primary ignition/combustion material (such as the primary ignition/combustion material 24).

As illustrated in FIG. 5, the formation of the enhanced charcoal briquette pile 40 can cause the normal, natural stacking of enhanced charcoal briquettes according to an increased pile sparsity (decreased density of enhanced charcoal briquettes in the enhanced charcoal briquette pile 40). This sparsity can be facilitated by two offset distances maintained between the enhanced charcoal briquettes (e.g., 20) in the enhanced charcoal briquette pile 40 that is caused at least in part by the coating of primary ignition/combustion material (e.g., 24) on the charcoal briquettes (e.g., 22). A first offset distance x illustrates the distance between a center of the first enhanced charcoal briquette 40a and a center of the second enhanced charcoal briquette 40b. A second offset distance y illustrates the distances between a surface of the first enhanced charcoal briquette 40a that is closest to the second enhanced charcoal briquette 40b and a surface of the second enhanced charcoal briquette 40b that is closest to the first enhanced charcoal briquette 40a. The two offset distances x, y can be linked or otherwise connected such that as one increases/decreases, the other increases/decreases accordingly.

As shown in FIG. 5, which includes a cutaway of the coating on each of the charcoal briquettes, the second offset distance y is also a non-zero value. In a settled pile of conventional charcoal briquettes (e.g., 10) that are not at least partially coated with a primary ignition/combustion material (e.g., 24), when two opposing faces of a first and second charcoal briquette (e.g., 10) are facing, that offset distance would be zero. However, because of the coating of the primary ignition/combustion material on the enhanced charcoal briquettes 40a, 40b, the distance between the enhanced charcoal briquettes 40a, 40b increases to a non-zero value. Even if one of the enhanced charcoal briquettes 40a, 40b were uncoated by the primary ignition/combustion material, or if one of the enhanced charcoal briquettes 40a, 40b were rotated such that the combustible coating of the primary ignition/combustion material was facing away from the other of the enhanced charcoal briquettes 40a, 40b, the second offset distance y would still be a non-zero value.

The increased offset distances x, y between the enhanced charcoal briquettes 40a, 40b increases the sparsity of the pile of enhanced charcoal briquettes 40 and provides for improved air flow and air channeling through the pile. Further, after ignition of a portion of the primary ignition/combustion material at the edge of the pile of enhanced charcoal briquettes 40, the ignited portion of the primary ignition/combustion material at the edge of the pile of enhanced charcoal briquettes 40 subsequently ignites other portions of the primary ignition/combustion material at other points about the pile of enhanced charcoal briquettes 40 and within the pile of enhanced charcoal briquettes 40. The primary ignition/combustion material undergoes effectively complete combustion rather quickly relative to the charcoal briquettes, and lead to increased points of ignition of the charcoal briquettes throughout the pile of enhanced charcoal briquettes 40. After effectively complete combustion of the primary ignition/combustion material in the pile of enhanced charcoal briquettes 40, channels will remain between the charcoal briquettes in the pile of enhanced charcoal briquettes 40, which will maintain a non-zero offset between some or all of the charcoal briquettes in the pile 40. The channels will facilitate continued airflow through the pile of enhanced charcoal briquettes 40 to aid in oxygen delivery to charcoal briquettes throughout the pile of enhanced charcoal briquettes 40, thereby improving the continued ignition and effective combustion of charcoal briquettes throughout the pile of enhanced charcoal briquettes 40.

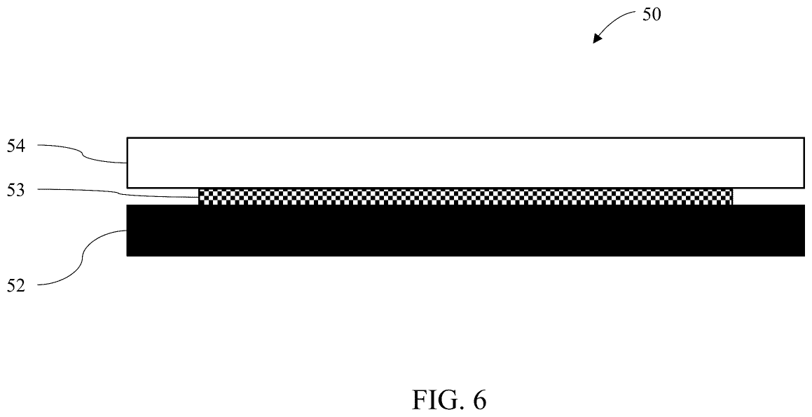

Referring now to FIGS. 6-12, an enhanced charcoal briquette 50 is illustrated, according to several embodiments of the present disclosure. The enhanced charcoal briquette 50 comprises a charcoal briquette 52 and a combustible coating 54 supported on an outer surface of the charcoal briquette 52. The charcoal briquette 52 can be similar to or the same as the charcoal briquette 10, the charcoal briquette 22, and/or the charcoal briquette 32. Alternatively, the enhanced charcoal briquette 50 can comprise any other suitable charcoal briquette or solid fuel material, whether having the same or a different composition, dimensions, form factor, and/or the like as the charcoal briquettes 10, 22, 32. The combustible coating 54 can be similar to or the same as the primary ignition/combustion material 24, 31. Alternatively, the combustible coating 54 can comprise any other suitable combustible material, whether having the same or a different composition, dimensions, form factor, and/or the like as the primary ignition/combustion material 24, 31.

As illustrated in FIG. 6, the enhanced charcoal briquette 50 further comprises an adhesive 53 disposed on at least a portion of an outside surface of the charcoal briquette 52. The adhesive 53 can comprise any suitable material, such as a glue, cement, epoxy, paste, mucilage, binder, crosslinking agent, or the like. The adhesive 53 can comprise a bio-based adhesive material, a polymer-containing material, a polymer-based material, or the like. The adhesive 53 can comprise polyvinyl acetates, polyesters, polyurethyanes, polyols, acrylics, polyimides, cyanoacrylates, dextrins, elastomers, and/or the like. In some embodiments, one or more materials the adhesive 53 can be chosen based on a combustibility of the materials, a flammability of the materials, an energy density of the materials, and/or the like. In some embodiments, the one or more materials for the adhesive 53 can have a first combustion rate that is greater than about 20% of a second combustion rate of the charcoal briquette 52, greater than about 25% of a second combustion rate of the charcoal briquette 52, greater than about 30% of a second combustion rate of the charcoal briquette 52, greater than about 35% of a second combustion rate of the charcoal briquette 52, greater than about 40% of a second combustion rate of the charcoal briquette 52, or greater than about 45% of a second combustion rate of the charcoal briquette 52, greater than about 50% of a second combustion rate of the charcoal briquette 52, greater than about 60% of a second combustion rate of the charcoal briquette 52, greater than about 70% of a second combustion rate of the charcoal briquette 52, or greater than about 80% of a second combustion rate of the charcoal briquette 52, inclusive of all values and ranges therebetween.

The adhesive 53 can cover the entire outer surface of the charcoal briquette 52, or only a portion of the outer surface of the charcoal briquette 52. For example, the adhesive 53 can cover between about 5% and about 95% of the outer surface of the charcoal briquette 52, between about 10% and about 90% of the outer surface of the charcoal briquette 52, between about 15% and about 85% of the outer surface of the charcoal briquette 52, between about 20% and about 80% of the outer surface of the charcoal briquette 52, between about 25% and about 75% of the outer surface of the charcoal briquette 52, between about 5% and about 85% of the outer surface of the charcoal briquette 52, between about 5% and about 75% of the outer surface of the charcoal briquette 52, between about 5% and about 65% of the outer surface of the charcoal briquette 52, between about 5% and about 55% of the outer surface of the charcoal briquette 52, between about 15% and about 95% of the outer surface of the charcoal briquette 52, between about 25% and about 95% of the outer surface of the charcoal briquette 52, between about 35% and about 95% of the outer surface of the charcoal briquette 52, between about 45% and about 95% of the outer surface of the charcoal briquette 52, between about 55% and about 95% of the outer surface of the charcoal briquette 52, greater than about 5% of the outer surface of the charcoal briquette 52, or less than about 95% of the outer surface of the charcoal briquette 52, inclusive of all values and ranges therebetween.

As illustrated in FIG. 6, the combustible coating 54 can be coupled to the charcoal briquette 52 by way of the adhesive 53. The combustible coating 54 can comprise kraft paper, bond paper, parchment, tissue paper, filter paper, coated paper, uncoated paper, cardstock, cardboard, newsprint, recycled paper, thermal paper, carbonless paper, Bristol paper, vellum, corrugated paper, wove paper, laid paper, cotton, linen, tag paper, glassine, sulphite paper, cover stock, manifold paper, wax paper, construction paper, perforated paper, synthetic paper, butcher paper, stone paper, quilling paper, crepe paper, flocked paper, gummed paper, oatmeal paper, tea paper, velvet paper, heat transfer paper, dissolvable paper, dissolving pulp, absorbent paper, abaca paper, hemp paper, bamboo paper, tobacco paper, shoe paper, book paper, banana paper, flax paper, beeswax paper, and/or the like.

As illustrated in FIG. 6, the adhesive 53 may coat a same percentage of the charcoal briquette 52 as the combustible coating 54, or less than the percentage of the charcoal briquette 52 as the combustible coating 54. For example, in some embodiments, the combustible coating 54 may cover about 50% of the charcoal briquette 52 while the adhesive 53 covers only between about 5% and about 25% of the charcoal briquette 52. In some embodiments, the adhesive 53 can be applied to the outer surface of the charcoal briquette 52, such as in the form of strips, droplets, a continuous coating, a discontinuous coating, or the like. Depending on the material used for the combustible coating 54, and the material used for the adhesive 53, portions of the combustible coating 54, once coupled to the outer surface of the charcoal briquette 52, can establish or maintain a distance above the outer surface of the charcoal briquette 52, such as by a curling up of the edges of the combustible coating 54 or otherwise.

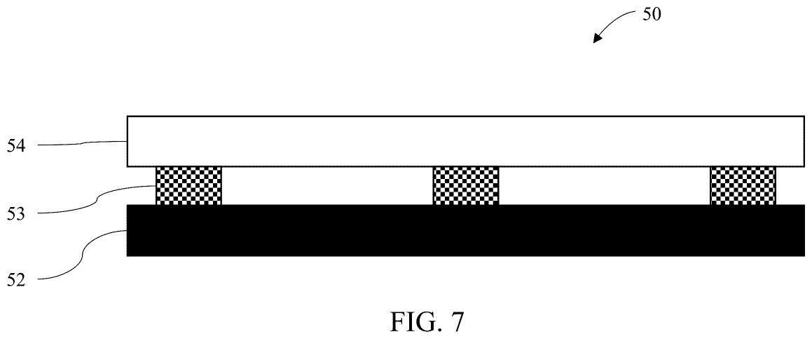

Illustrated in FIG. 7 is an alternative cross-sectional view of the enhanced charcoal briquette 50, according to an embodiment of the present disclosure. The cross-section of the enhanced charcoal briquette 50 as illustrated in FIG. 7 can comprise the same charcoal briquette 52 as illustrated in FIG. 6, or any other suitable solid fuel material have any suitable composition, form factor, and dimensions.

The enhanced charcoal briquette 50 as illustrated in FIG. 7 further comprises an adhesive 53 disposed on at least a portion of an outside surface of the charcoal briquette 52. The adhesive 53 can comprise any suitable material, such as a glue, cement, epoxy, paste, mucilage, binder, crosslinking agent, or the like. The adhesive 53 can comprise a bio-based adhesive material, a polymer-containing material, a polymer-based material, or the like. The adhesive 53 can comprise polyvinyl acetates, polyesters, polyurethyanes, polyols, acrylics, polyimides, cyanoacrylates, dextrins, elastomers, and/or the like. In some embodiments, one or more materials the adhesive 53 can be chosen based on a combustibility of the materials, a flammability of the materials, an energy density of the materials, and/or the like. In some embodiments, the one or more materials for the adhesive 53 can have a first combustion rate that is greater than about 20% of a second combustion rate of the charcoal briquette 52, greater than about 25% of a second combustion rate of the charcoal briquette 52, greater than about 30% of a second combustion rate of the charcoal briquette 52, greater than about 35% of a second combustion rate of the charcoal briquette 52, greater than about 40% of a second combustion rate of the charcoal briquette 52, or greater than about 45% of a second combustion rate of the charcoal briquette 52, greater than about 50% of a second combustion rate of the charcoal briquette 52, greater than about 60% of a second combustion rate of the charcoal briquette 52, greater than about 70% of a second combustion rate of the charcoal briquette 52, or greater than about 80% of a second combustion rate of the charcoal briquette 52, inclusive of all values and ranges therebetween.

The adhesive 53 can cover the entire outer surface of the charcoal briquette 52, or only a portion of the outer surface of the charcoal briquette 52. For example, the adhesive 53 can cover between about 5% and about 95% of the outer surface of the charcoal briquette 52, between about 10% and about 90% of the outer surface of the charcoal briquette 52, between about 15% and about 85% of the outer surface of the charcoal briquette 52, between about 20% and about 80% of the outer surface of the charcoal briquette 52, between about 25% and about 75% of the outer surface of the charcoal briquette 52, between about 5% and about 85% of the outer surface of the charcoal briquette 52, between about 5% and about 75% of the outer surface of the charcoal briquette 52, between about 5% and about 65% of the outer surface of the charcoal briquette 52, between about 5% and about 55% of the outer surface of the charcoal briquette 52, between about 15% and about 95% of the outer surface of the charcoal briquette 52, between about 25% and about 95% of the outer surface of the charcoal briquette 52, between about 35% and about 95% of the outer surface of the charcoal briquette 52, between about 45% and about 95% of the outer surface of the charcoal briquette 52, between about 55% and about 95% of the outer surface of the charcoal briquette 52, greater than about 5% of the outer surface of the charcoal briquette 52, or less than about 95% of the outer surface of the charcoal briquette 52, inclusive of all values and ranges therebetween.

As illustrated in FIG. 6, the combustible coating 54 can be coupled to the charcoal briquette 52 by way of the adhesive 53. The combustible coating 54 can comprise kraft paper, bond paper, parchment, tissue paper, filter paper, coated paper, uncoated paper, cardstock, cardboard, newsprint, recycled paper, thermal paper, carbonless paper, Bristol paper, vellum, corrugated paper, wove paper, laid paper, cotton, linen, tag paper, glassine, sulphite paper, cover stock, manifold paper, wax paper, construction paper, perforated paper, synthetic paper, butcher paper, stone paper, quilling paper, crepe paper, flocked paper, gummed paper, oatmeal paper, tea paper, velvet paper, heat transfer paper, dissolvable paper, dissolving pulp, absorbent paper, abaca paper, hemp paper, bamboo paper, tobacco paper, shoe paper, book paper, banana paper, flax paper, beeswax paper, and/or the like.

A thickness of the combustible coating 54 can vary across the surface of the charcoal briquette 52. In some embodiments, since the thickness of the combustible coating 54 varies across the surface of the charcoal briquette 52, an average/mean thickness of the combustible coating 54 can be used. In some embodiments, the mean thickness of the combustible coating 54 can be between about 100 μm and about 50 mm, between about 500 μm and about 45 mm, between about 1,000 μm and about 40 mm, between about 1,500 μm and about 35 mm, between about 2,000 μm and about 30 mm, between about 2,500 μm and about 25 mm, between about 3,000 μm and about 20 mm, between about 5 mm and about 10 mm, between about 500 μm and about 50 mm, between about 1,000 μm and about 50 mm, between about 2,000 μm and about 50 mm, between about 3,000 μm and about 50 mm, between about 5 mm and about 50 mm, between about 100 μm and about 25 mm, between about 100 μm and about 20 mm, between about 100 μm and about 15 mm, between about 100 μm and about 10 mm, between about 100 μm and about 5 mm, less than about 50 mm, less than about 25 mm, less than about 20 mm, less than about 15 mm, less than about 10 mm, less than about 5 mm, greater than about 5 mm, greater than about 10 mm, greater than about 15 mm, greater than about 20 mm, greater than about 25 mm, or greater than about 50 mm, inclusive of all values and ranges therebetween.

As illustrated in FIG. 7, the adhesive 53 can be applied to a surface of the charcoal briquette 52 as a plurality of discrete portions or volumes. For example, the adhesive 53 can be applied to a surface of the charcoal briquette 52 as strips, drops, line segments, or according to any other suitable form factor and/or dimensions. In some embodiments, by applying discrete portions of the adhesive 53, a ratio range or ratio value of the adhesive 53 to the combustible coating 54 can be achieved. According to some embodiments, the ratio (range or value) of the adhesive 53 to the combustible coating 54 can be a volume ratio, a mass ratio, a caloric ratio, an energy density ratio, a calorie-normalized volume ratio, a calorie-normalized mass ratio, any combination thereof, or the like. For example, a material or combination of materials used for the adhesive 53 may have a first caloric value (unit of energy based on a mass amount of a material for which the combustion of the mass amount of that material results in an increase in a temperature of a kilogram of water by one degree C.), while the combustible coating 54 may have a second caloric value. The energy density/caloric value of each of these materials can be compared and weighed against other factors such as combustion rate, ignitability, pile density, pile air flow characteristics, material costs, manufacturing difficulty, and/or the like, to arrive at one or more optimal ratios or ratio ranges of the adhesive 53 to the combustible coating 54.

In some embodiments, a ratio of between about 1:2 and about 1:6 of the adhesive 53 to the combustible coating 54 can be used. In other embodiments, a ratio of between about 1:1 and about 1:4 of the adhesive 53 to the combustible coating 54 can be used. In still other embodiments, such as when ignition and/or combustion characteristics of the adhesive 53 do not necessarily improve the ignition and/or combustion characteristics of the enhanced charcoal briquette 50, cither generally or with regard to a mass or volume equivalent amount of the combustible coating 54, a ratio of less than about 1:2 of the adhesive 53 to the combustible coating 54 can be used. In yet other embodiments, such as when the ignition and/or combustion characteristics of the adhesive 53 improves the ignition and/or combustion characteristics of the enhanced charcoal briquette 50, a ratio of greater than about 1:2 of the adhesive 53 to the combustible coating 54 can be used. In some embodiments, the ignition and/or combustion characteristics of the adhesive 53 may be equivalent to or greater than the ignition and/or combustion characteristics of the combustible coating 54, but an increased ratio of the adhesive 53 to the combustible coating 54 may nevertheless lead to reduced ignition and/or combustion characteristics of the enhanced charcoal briquette 50, e.g., because airflow through the pile is reduced with certain increases in said ratio of the adhesive 53 to the combustible coating 54. The ‘certain increases’ may refer to increases in said ratio of the adhesive 53 to the combustible coating 54 within a particular range, at ratios greater than a particular ratio value, at ratios less than a particular ratio value, and/or the like.

The optimization of this ratio of the adhesive 53 to the combustible coating 54, however, is not entirely independent from ignition and/or combustion characteristics of the charcoal briquette 52. Furthermore, the ignition and/or combustion characteristics of each of the charcoal briquette 52, the adhesive 53, and the combustible coating 54 can depend on factors other than just a ratio (mass, volume, energy density, etc.) of each material to the others, such as material choice, combustion application, pile characteristics such as height and pile edge slope, and/or the like.

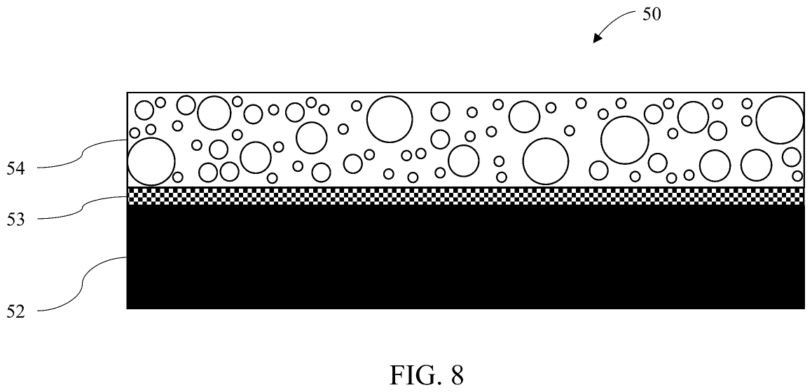

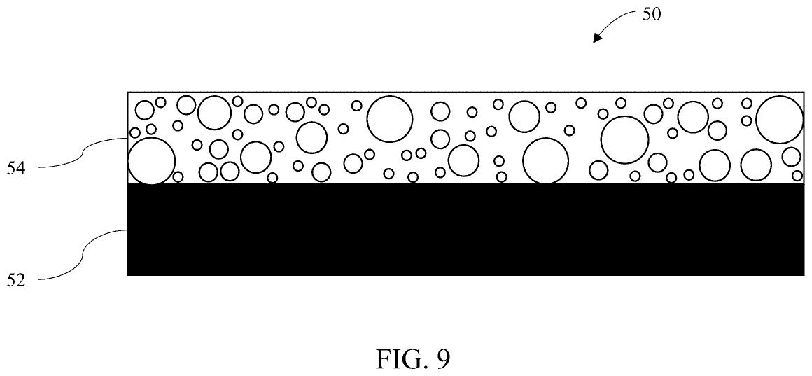

Illustrated in FIGS. 8 and 9 are embodiments of the enhanced charcoal briquette 50 in which the combustible coating 54 can be or comprise a porous material. The porous material can comprise a plurality of pores or air pockets that retain a liquid or a gas. In some embodiments, the pores of the porous material can comprise a gas that aids in ignition and/or combustion of the combustible coating 54, such as methane, butane, propane, hydrogen, acetylene, ethylene, ammonia, ethane, other suitable gases, and/or combinations thereof. In other embodiments, the pores of the porous material can comprise a gas mixture that is or is similar to an average atmospheric gas mixture, such as a gas mixture that comprises about 78% nitrogen, 21% oxygen, and 1% argon, with trace gases, particulars, and contaminants constituting the balance of the gas mixture.

In some embodiments, the combustible coating 54 can comprise an aerogel. A stable aerogel can be formed from a gel in which the liquid component for the gel is replaced with a gas, such as (but not limited to) a flammable/combustible gas. The aerogel can comprise a carbon aerogel with particle sizes in the nanometer range and having a porosity of between about 10% and about 50%, with a pore diameter of between about 20 nm and about 1,000 nm. In other embodiments, the aerogel can be formed from agar, polyimides, cellulose, and/or the like.

As shown in FIG. 8, combustible coating 54 comprising the porous material can be coupled to the charcoal briquette 52 using the adhesive 53. In some embodiments in which the combustible coating 54 may be coupled to the charcoal briquette 52 using the adhesive 53, a natural biopolymer such as kraft pulp or the like can be collected and shaped into an appropriate form factor to form the combustible coating 54, and thereafter coupled to the charcoal briquette 52 using the adhesive 53.

Alternatively, as shown in FIG. 9, the combustible coating 54 comprising the porous material can be directly disposed on and/or coupled to the charcoal briquette 52. Without wishing to be bound by any particular theory, the porous material of the combustible coating 54 may be coupled to the surface of the charcoal briquette 52 through surface adhesion or bonding of one to the other. This can be accomplished by forming a non-porous material or a relatively less porous material directly on the surface of the charcoal briquette 52 and infusing the material with a gas or gas mixture to form the combustible coating 54 comprising the porous material. For example, a polymer or paper material can be track-etched, stretched, phase-separated, gas injected, bubbled, or otherwise infused with the gas or gas mixture. A biopolymer can be formed by hydrolyzing natural fibers and repolymerizing the monomers/dimers formed therefrom, into synthetic biopolymers such as poly lactic acid or the like. A material such as cellulose, chitosan, collagen, or the like can form naturally and may be collected and treated to fabricate a porous biopolymer material comprising macromolecules of the natural biopolymer material. Certain biopolymers may be chosen for the porous material based on surface area-to-volume ratio, crystallinity, pore size, porosity, flammability, combustibility, ignitability, energy density, and/or other factors.

A biopolymer scaffold can be formed and polymerization of a synthetic biopolymer can be initiated thereon. In some embodiments, such as when the combustible coating 54 is formed directly on/joined directly to the charcoal briquette 52, a biopolymer scaffold can be formed directly on the outer surface of the charcoal briquette 52 or on a polymerization substrate and later transferred to the outer surface of the charcoal briquette 52. In some embodiments, the outer surface of the charcoal briquette 52 may have a natural texture sufficient for interleaving, meshing, linking, interconnecting, interlacing, or otherwise connecting the biopolymer/polymer or biopolymer scaffold directly therewith. For example, the outer surface of the charcoal briquette 52 may be roughened, may include structures (e.g., microscale structures) that stand proud of the outer surface, may include pores/apertures therein, may include general microtopographic variation, and/or may include other structures to which the combustible coating 54 can be directly coupled. While shown as comprising closed pores in FIGS. 8 and 9, the porous material can additionally or alternatively include open pores.

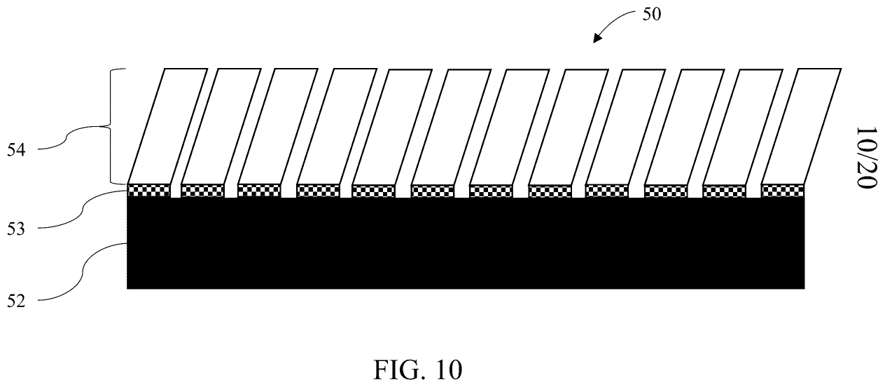

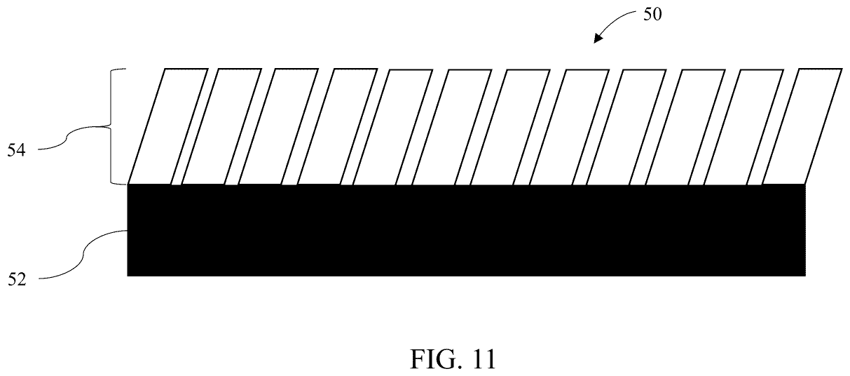

Illustrated in FIGS. 10-12 are alternative embodiments of the enhanced charcoal briquette 50 in which the combustible coating 54 can comprise discrete portions of a combustible material that are coupled to (FIGS. 9 and 11) or are disposed directly on (FIG. 10) the outer surface of the charcoal briquette 52 on respective discrete portions/places on the outer surface of the charcoal briquette 52.

As shown in FIG. 10, discrete portions of the combustible material can comprise strips of the combustible material. Strips can have any suitable dimensions or form factor, such as being rectangular in shape, square in shape, or otherwise. A single edge or a portion of a single edge of each strip can be coupled to the surface of the charcoal briquette 52.

As shown in FIG. 10, combustible coating 54 comprising the porous material can be coupled to the charcoal briquette 52 using the adhesive 53. In some embodiments in which the combustible coating 54 may be coupled to the charcoal briquette 52 using the adhesive 53, a natural biopolymer such as kraft pulp or the like can be collected and shaped into an appropriate form factor to form the combustible coating 54, and thereafter coupled to the charcoal briquette 52 using the adhesive 53.

Alternatively, as shown in FIG. 11, the combustible coating 54 can be directly disposed on and/or coupled to the charcoal briquette 52. Without wishing to be bound by any particular theory, the strips comprising the combustible coating 54 may be coupled to the surface of the charcoal briquette 52 through surface adhesion or bonding of one to the other. This can be accomplished by wetting a portion of each strip, contacting the portion of the strip to the outer surface of the charcoal briquette 52, and allowing the strip to dry. Alternatively, this can be accomplished by heating a portion of each strip, contacting a portion of each strip to the outer surface of the charcoal briquette 52, and allowing each strip to cool. For example, a polymer (e.g., thermoplastic polymer) material can be shaped or formed into a strip, one end of the strip can be heated to partially melt the thermoplastic polymer, the end of the strip can be contacted with the outer surface of the charcoal briquette 52, and as the partially melted portion of the thermoplastic polymer strip cools, it adheres, cross-links to, physically interleaves with, or otherwise is coupled to the outer surface of the charcoal briquette 52.

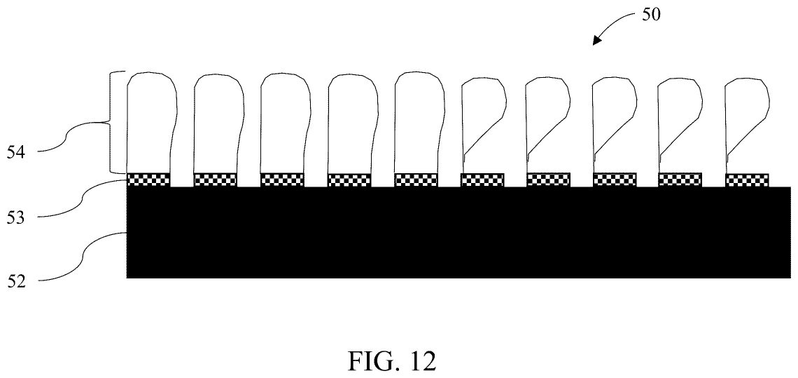

Additionally or alternatively, such as shown in FIG. 12, the discrete portions of the combustible material can comprise loops of the combustible material. The loops can have the same or a different form factor as the strips. In some embodiments, more than one edge or a portion of more than one edge of the loop can be coupled to the surface of the charcoal briquette 52. In other embodiments, one edge or a portion of one edge of a strip can be couple to the surface of the charcoal briquette 52 while another edge or a portion of another edge of the strip can be looped back and coupled to the strip itself closer to the edge of the strip coupled to the surface of the charcoal briquette 52.

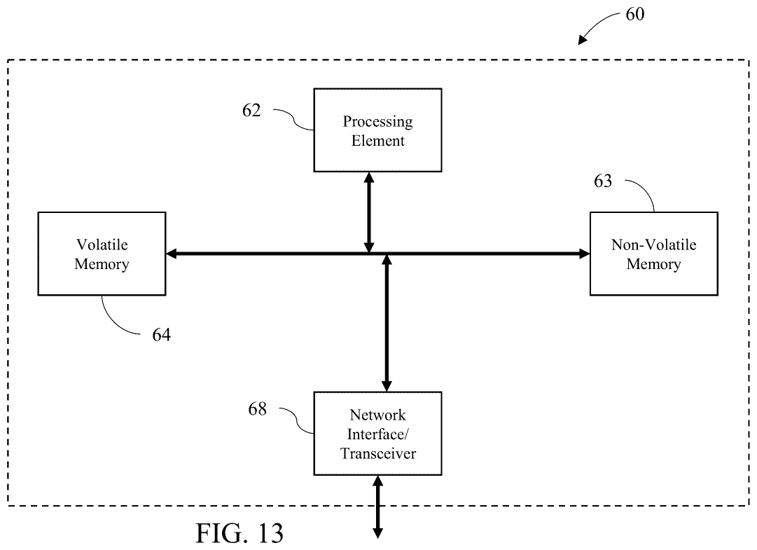

Processes (e.g., 30) for fabricating/manufacturing enhanced charcoal briquettes (e.g., 20, 50), or portions thereof, can be carried out by a computing device, such as computing device 60 illustrated in FIG. 13. As such, embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language, such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### Example Computing Device

Referring again to FIG. 13, illustrated therein is a schematic of a computing device 60 that can be configured to monitor and control a manufacturing system/device (e.g., 30) for manufacturing an enhanced charcoal briquette (e.g., 20, 50). Alternatively, the computing device 60 can be configured to cause a device to apply a combustible coating (e.g., 24, 54) to one or more surfaces of a charcoal briquette (e.g., 10, 22, 52). The computing device 60 may comprise one or more processing elements 62, one or more non-volatile memories 63, one or more volatile memories 64, and/or one or more transmitter/receivers 68 (e.g., “transceivers 68”).

In some embodiments, the computing device 60 is configured to store one or more computer program products, computer program code, a computer-readable media comprising instructions, and/or the like. In some embodiments, the computing device 60 is configured to determine or receive information regarding at least a portion of an enhanced charcoal briquette manufacturing process, such as feedstock composition, feedstock moisture content, feedstock density, densification process configurations and metrics, and/or other information regarding a current status of the system.

In some embodiments, the computing device 60 is configured to carry out at least a part of one of the processes/methods described herein (e.g., 30, 70, 80, 90, 100, 110, 120) in the full or partial manufacture or formation of enhanced charcoal briquettes (e.g., 20, 50). Information can be received by the computing device 60 from a manual input, one or more sensors, and/or the like. In some embodiments, the computing device 60 is configured, using any suitable means, to be in wired or wireless communication, such as via the transceivers 68, with one or more motors, conveyors, valves, actuators, pumps, sensors, and/or the like (not shown). The computing device 60 can be configured to directly control equipment such as a mill, briquetting machine, press, heater, torrefaction chamber, furnace, kiln, or devices for controlling the same (e.g., to carry out all or part of the process 30). In some embodiments, the computing device 60 can be configured to communicate a set of instructions to one or more motors, actuators, sensors, valves, pumps, and/or the like, for one or a series of actions to be carried out. For example, the computing device 60 can provide flow rate instructions, e.g., in conjunction with other instructions, to one or more of motors, actuators, sensors, valves, pumps, and/or the like in order for the proper flow rate or discrete volume of a slurry of combustible material to be communicated to a surface of a charcoal briquette (e.g., 10, 22, 52), or a portion thereof.

In some embodiments, the computing device 60 can be configured to cause one or more devices to perform a method of manufacturing an enhanced charcoal briquette (e.g., 20, 50). This can be based upon computer-readable instructions or computer code stored in one or more memories of the computing device 60 that are executable by one or more processors of the computing device 60. For example, the computing device 60 can cause one or more pumps or conveyors or the like to communicate a combustible material into a mixing container containing a volume of a liquid solvent. The computing device 60 can be configured to control the pumps, conveyors, or the like, such as by sending commands, instructions, electrical signals, or the like directly to the pump, conveyor, or the like, and/or by sending commands, instructions, electrical signals, or the like to a controller or processor that controls the pump, conveyor, or the like.

The computing device 60 can cause one or more mixing devices to mix or otherwise combine the combustible material and the volume of the liquid solvent to form a combustible solution. The computing device 60 can be configured to control the mixing device(s) by sending commands, instructions, electrical signals, or the like directly to the mixing device(s) and/or by sending commands, instructions, electrical signals, or the like to a controller or processor that controls the mixing device(s).

The computing device 60 can be configured to control one or more pumps, nozzles, robotic arms, actuators, valves, meters, and/or the like to dispose at least a portion of the combustible solution onto at least a portion of an outer surface of one or more charcoal briquettes (e.g., 10, 22, 32, 52), such as by sending commands, instructions, electrical signals, or the like directly to the pumps, nozzles, robotic arms, actuators, valves, meters, and/or the like, and/or by sending commands, instructions, electrical signals, or the like to a controller or processor that controls the pumps, nozzles, robotic arms, actuators, valves, meters, and/or the like.

The computing device 60 can be configured to control one or more dryers, robotic arms, conveyors, motors, pumps, screens, meters, and/or the like to at least partially dry the combustible solution disposed onto at least a portion of the outer surface of the one or more charcoal briquettes (e.g., 10, 22, 32, 52), such as by sending commands, instructions, electrical signals, or the like directly to the dryers, robotic arms, conveyors, motors, pumps, screens, meters, and/or the like, and/or by sending commands, instructions, electrical signals, or the like to a controller or processor that controls the dryers, robotic arms, conveyors, motors, pumps, screens, meters, and/or the like.

Alternatively, the computing device 60 can provide or cause provisioning of a sheet of combustible material. The computing device 60 can be configured, for example, to control one or more motors, rollers, conveyors, robotic arms, valves, air compressors, nozzles, pumps, meters, sensors, and/or the like to provide a sheet of the combustible material. The sheet of the combustible material can be provided continuously, semi-continuously, in a batch-wise manner, sporadically, iteratively, on demand, as available, or otherwise (e.g., depending on bottlenecks in the manufacturing process and other factors). The computing device 60 can be configured to control the motors, rollers, conveyors, robotic arms, valves, air compressors, nozzles, pumps, meters, sensors, and/or the like by sending commands, instructions, electrical signals, or the like directly to the mixing device(s) and/or by sending commands, instructions, electrical signals, or the like to a controller or processor that controls the motors, rollers, conveyors, robotic arms, valves, air compressors, nozzles, pumps, meters, sensors, and/or the like.

The computing device 60 can be configured to control one or more pumps, motors, nozzles, robotic arms, conveyors, meters, reservoirs, adhesive applicators, and/or the like to apply an adhesive to at least a portion of an outer surface of one or more charcoal briquettes (e.g., 10, 22, 32, 52) or at least a portion of the sheet of the combustible material, such as by sending commands, instructions, electrical signals, or the like directly to the pumps, motors, nozzles, robotic arms, conveyors, meters, reservoirs, adhesive applicators, and/or the like, and/or by sending commands, instructions, electrical signals, or the like to a controller or processor that controls the pumps, motors, nozzles, robotic arms, conveyors, meters, reservoirs, adhesive applicators, and/or the like.

The computing device 60 can be configured to control one or more motors, rollers, conveyors, robotic arms, valves, air compressors, nozzles, pumps, meters, sensors, and/or the like to dispose at least a portion of the sheet of the combustible material onto at least a portion of an outer surface of one or more charcoal briquettes (e.g., 10, 22, 32, 52) or to dispose at least a portion of the one or more charcoal briquettes (e.g., 10, 22, 32, 52) onto at least a portion of the sheet of the combustible material. The computing device 60 can be configured to carry this out by sending commands, instructions, electrical signals, or the like directly to the motors, rollers, conveyors, robotic arms, valves, air compressors, nozzles, pumps, meters, sensors, and/or the like, and/or by sending commands, instructions, electrical signals, or the like to a controller or processor that controls the motors, rollers, conveyors, robotic arms, valves, air compressors, nozzles, pumps, meters, sensors, and/or the like.

The computing device 60 can be configured to control one or more motors, rollers, conveyors, robotic arms, valves, air compressors, nozzles, pumps, meters, sensors, cutting devices, laser devices, and/or the like, to separate the sheet of combustible material into discrete portions comprising one of the charcoal briquettes (e.g., 10, 22, 32, 52) coupled thereto. The computing device 60 can be configured to carry this out by sending commands, instructions, electrical signals, or the like directly to the motors, rollers, conveyors, robotic arms, valves, air compressors, nozzles, pumps, meters, sensors, cutting devices, laser devices, and/or the like, and/or by sending commands, instructions, electrical signals, or the like to a controller or processor that controls the motors, rollers, conveyors, robotic arms, valves, air compressors, nozzles, pumps, meters, sensors, cutting devices, laser devices, and/or the like.

In general, the terms computing device, computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As shown in FIG. 13, in one embodiment, the computing device 60 may include or be in communication with one or more processing elements 62 (also referred to as processors, processing circuitry, and/or similar terms used herein interchangeably) that communicate with other elements within the computing device 60 via a bus, for example. As will be understood, the processing element 62 may be embodied in a number of different ways. For example, the processing element 62 may be embodied as one or more complex programmable logic devices (CPLDs), microprocessors, multi-core processors, coprocessing entities, application-specific instruction-set processors (ASIPs), microcontrollers, and/or controllers. Further, the processing element 62 may be embodied as one or more other processing devices or circuitry. The term circuitry may refer to an entirely hardware embodiment or a combination of hardware and computer program products. Thus, the processing element 62 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 62 may be configured for a particular use or configured to execute instructions stored in volatile or non-volatile media or otherwise accessible to the processing element 62. As such, whether configured by hardware or computer program products, or by a combination thereof, the processing element 62 may be capable of performing steps or operations according to embodiments of the present invention when configured accordingly.

In one embodiment, the computing device 60 may further include or be in communication with non-volatile media (also referred to as non-volatile storage, memory, memory storage, memory circuitry, and/or similar terms used herein interchangeably). In one embodiment, the non-volatile storage or memory may include the one or more non-volatile memories 63, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the computing device 60 may further include or be in communication with volatile media (also referred to as volatile storage, memory, memory storage, memory circuitry, and/or similar terms used herein interchangeably). In one embodiment, the volatile storage or memory may also include one or more volatile memories 64, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 62. Thus, the databases, database instances, database management systems, data, applications, programs, program modules, scripts, source code, object code, byte code, compiled code, interpreted code, machine code, executable instructions, and/or the like may be used to control certain aspects of the operation of the computing device 60 with the assistance of the processing element 62 and operating system.

In some embodiments, the computing device 60 may also include one or more network interfaces, such as a transceiver 68 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing device 60 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing device 60 may include or be in communication with one or more input elements, such as a keyboard input, a mouse input, a touch screen/display input, motion input, movement input, audio input, pointing device input, joystick input, keypad input, and/or the like. The computing device 60 may also include or be in communication with one or more output elements (not shown), such as audio output, video output, screen/display output, motion output, movement output, and/or the like.

Nevertheless, the computing device 60 can be configured to control elements of a system or device, such as that used in the process 30 described herein. The computing device 60 can be in operable communication with one or more sensors, one or more valves, one or more actuators, one or more conveyers, one or more motors, one or more pumps, one or more scales, one or more imaging devices, one or more radiation (e.g., infrared radiation [IR], near-IR) emission devices, one or more moisture content monitors, one or more rollers, one or more robotic arms, one or more presses, one or more pelletizers, one or more briquetting machines, one or more cameras, one or more emissions sensors, one or more torrefaction devices/systems, one or more kilns, one or more dryers (e.g., in-line dryers), one or more adhesive applicators, one or more reservoirs, one or more nozzles, one or more cutting edges, one or more laser devices, and/or the like.

In some embodiments, the computing device 60 can be configured to carry out most or all of a process of manufacturing enhanced charcoal briquettes (e.g., 20, 50). For example, the computing device 60 can be configured to prepare a briquette feedstock material, perform carbonization or torrefaction of the briquette feedstock material to form charcoal material, form the charcoal material into the charcoal briquette (e.g., 10, 22, 52), prepare and apply an adhesive (e.g., 53) if needed, prepare a combustible coating (e.g., 24, 54), and couple the combustible coating to the charcoal briquette to form the enhanced charcoal briquette (e.g., 20, 50). Alternatively, the computing device 60 can be configured to prepare a briquette feedstock material, form the briquette feedstock material into a green briquette, perform carbonization or torrefaction of the green briquette to form the charcoal briquette (e.g., 10, 22, 52), prepare and apply an adhesive (e.g., 53) if needed, prepare a combustible coating (e.g., 24, 54), and couple the combustible coating to the charcoal briquette to form the enhanced charcoal briquette (e.g., 20, 50).

Alternatively, in some embodiments, the computing device 60 can be configured to carry out only a portion of the process of manufacturing enhanced charcoal briquettes (e.g., 20, 50).

For example, the computing device 60 can be configured to prepare and apply an adhesive (e.g., 53) to a charcoal briquette (e.g., 10, 22, 52), prepare a combustible coating (e.g., 24, 54), and couple the combustible coating to the charcoal briquette using the adhesive to form the enhanced charcoal briquette (e.g., 20, 50). Alternatively, the computing device 60 can be configured to prepare a combustible coating (e.g., 24, 54) and couple the combustible coating directly to a charcoal briquette (e.g., 10, 22, 52) to form the enhanced charcoal briquette (e.g., 20, 50).

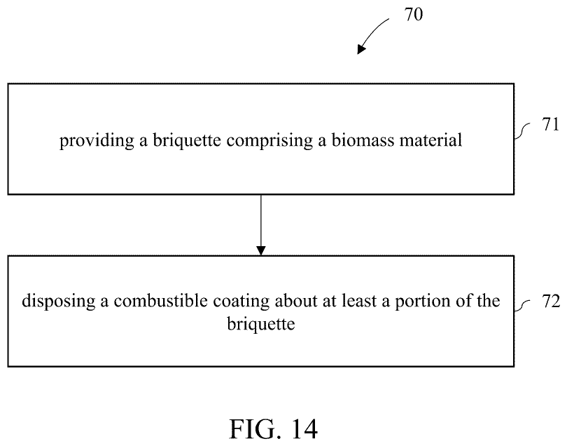

FIG. 14 illustrates a method 70 for manufacturing an enhanced charcoal briquette. The method 70 can comprise providing a briquette comprising a biomass material, at 71. The method 70 can further comprise disposing a combustible coating about at least a portion of the briquette, at 72.

Some or all of the elements of the method 70 can be carried out by or controlled by a computing device, such as computing device 60. For example, the processing element 62 of the computing device 60 can, based upon instructions/program code stored in the volatile memory 64 and/or the non-volatile memory 63, cause and control operation of another component or element of a system/device, such as a robotic arm, a conveyor belt, a furnace, a mill, a grinder, a press, rollers, and/or the like. By causing and controlling operation of another component or element, the computing device 60 can cause one or more elements of the method 70 to be carried out in part or in full. In some embodiments, the computing device 60 can comprise the other component or element for which the processing element 62 is causing and controlling operation thereof. In other embodiments, the computing device 60 can be configured to communicate with another apparatus, device, system, or the like, to cause control of the other component or element in accordance with one or more elements of the method 70, whether in part or in full.

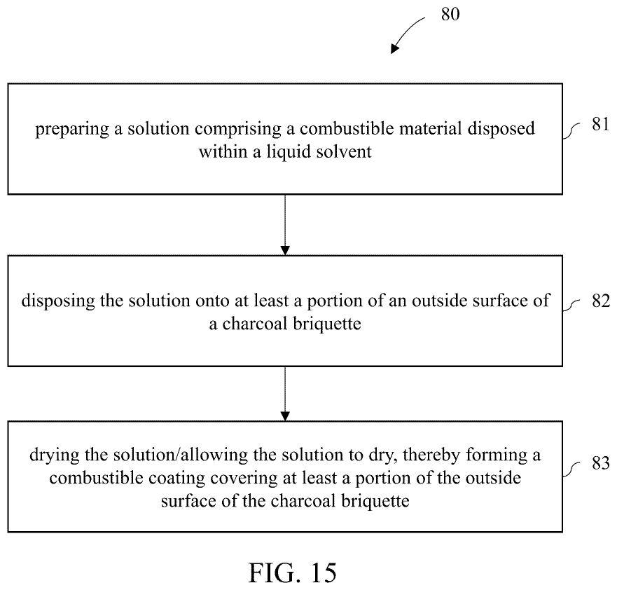

FIG. 15 illustrates a method 80 for manufacturing an enhanced charcoal briquette. The method 80 can comprise preparing a solution comprising a combustible material disposed within a liquid solvent, at 81. The method 80 can further comprise disposing the solution onto at least a portion of an outside surface of a charcoal briquette, at 82. The method 80 can further comprise drying the solution/allowing the solution to dry, thereby forming a combustible coating covering at least a portion of the outside surface of the charcoal briquette, at 83.

Some or all of the elements of the method 80 can be carried out by or controlled by a computing device, such as computing device 60. For example, the processing element 62 of the computing device 60 can, based upon instructions/program code stored in the volatile memory 64 and/or the non-volatile memory 63, cause and control operation of another component or element of a system/device, such as a robotic arm, a conveyor belt, a furnace, a mill, a grinder, a press, rollers, and/or the like. By causing and controlling operation of another component or element, the computing device 60 can cause one or more elements of the method 80 to be carried out in part or in full. In some embodiments, the computing device 60 can comprise the other component or element for which the processing element 62 is causing and controlling operation thereof. In other embodiments, the computing device 60 can be configured to communicate with another apparatus, device, system, or the like, to cause control of the other component or element in accordance with one or more elements of the method 80, whether in part or in full.

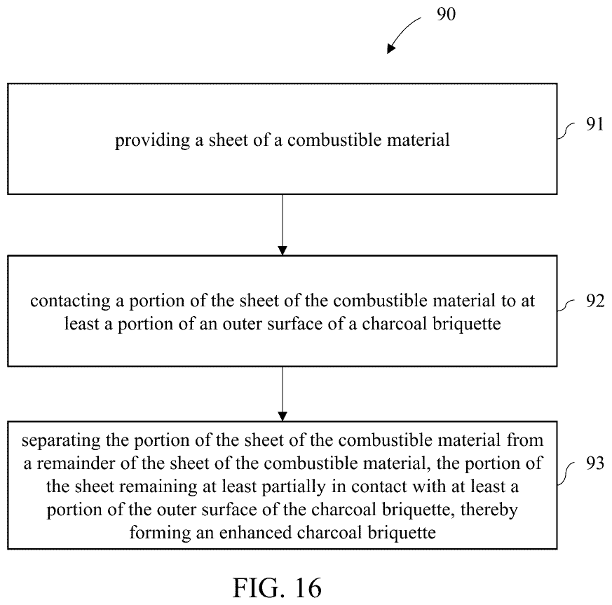

FIG. 16 illustrates a method 90 for manufacturing an enhanced charcoal briquette. The method 90 can comprise providing a sheet of a combustible material, at 91. The method 90 can further comprise contacting a portion of the sheet of the combustible material to at least a portion of an outer surface of a charcoal briquette, at 92. The method 90 can further comprise separating the portion of the sheet of the combustible material from a remainder of the sheet of the combustible material, the portion of the sheet remaining at least partially in contact with at least a portion of the outer surface of the charcoal briquette, thereby forming the enhanced charcoal briquette, at 93.

Some or all of the elements of the method 90 can be carried out by or controlled by a computing device, such as computing device 60. For example, the processing element 62 of the computing device 60 can, based upon instructions/program code stored in the volatile memory 64 and/or the non-volatile memory 63, cause and control operation of another component or element of a system/device, such as a robotic arm, a conveyor belt, a furnace, a mill, a grinder, a press, rollers, and/or the like. By causing and controlling operation of another component or element, the computing device 60 can cause one or more elements of the method 90 to be carried out in part or in full. In some embodiments, the computing device 60 can comprise the other component or element for which the processing element 62 is causing and controlling operation thereof. In other embodiments, the computing device 60 can be configured to communicate with another apparatus, device, system, or the like, to cause control of the other component or element in accordance with one or more elements of the method 90, whether in part or in full.

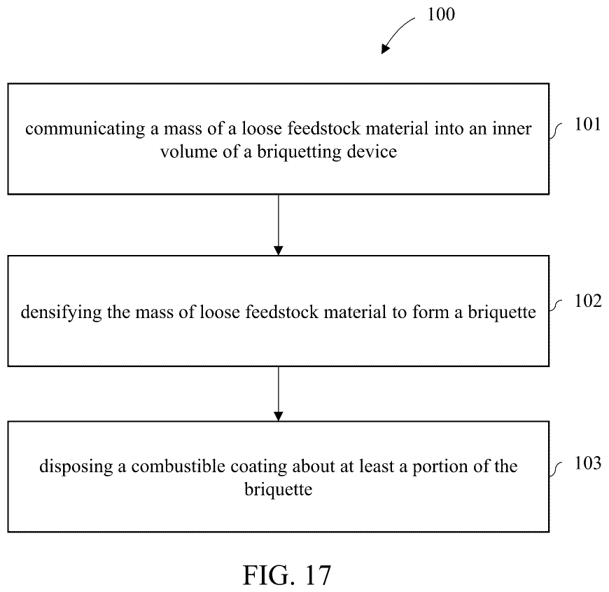

FIG. 17 illustrates a method 100 for manufacturing an enhanced charcoal briquette. The method 100 can comprise communicating a mass of a loose feedstock material into an inner volume of a briquetting device, at 101. The method 100 can further comprise densifying the mass of loose feedstock material to form a briquette, at 102. The method 100 can further comprise disposing a combustible coating about at least a portion of the briquette, at 103.

Some or all of the elements of the method 100 can be carried out by or controlled by a computing device, such as computing device 60. For example, the processing element 62 of the computing device 60 can, based upon instructions/program code stored in the volatile memory 64 and/or the non-volatile memory 63, cause and control operation of another component or element of a system/device, such as a robotic arm, a conveyor belt, a furnace, a mill, a grinder, a press, rollers, and/or the like. By causing and controlling operation of another component or element, the computing device 60 can cause one or more elements of the method 100 to be carried out in part or in full. In some embodiments, the computing device 60 can comprise the other component or element for which the processing element 62 is causing and controlling operation thereof. In other embodiments, the computing device 60 can be configured to communicate with another apparatus, device, system, or the like, to cause control of the other component or element in accordance with one or more elements of the method 100, whether in part or in full.

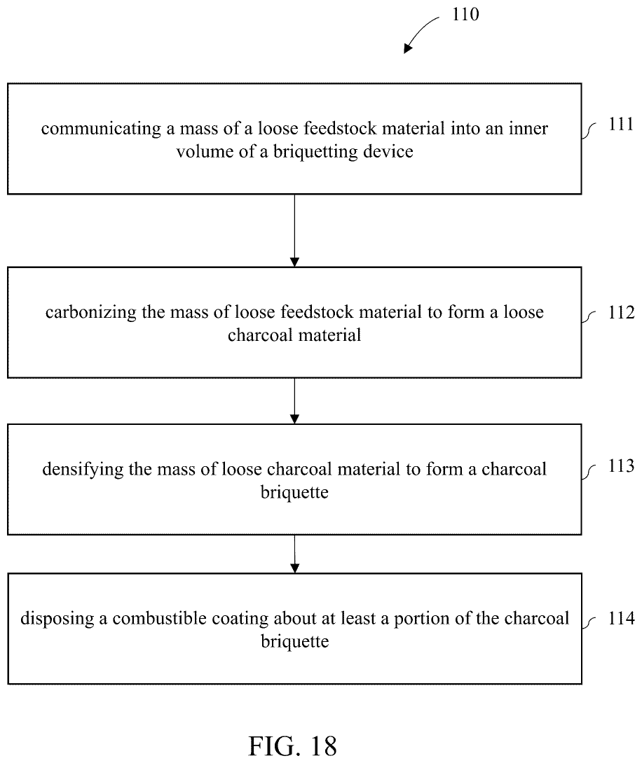

FIG. 18 illustrates a method 110 for manufacturing an enhanced charcoal briquette. The method 110 can comprise communicating a mass of a loose feedstock material into an inner volume of a briquetting device, at 111. The method 110 can further comprise carbonizing the mass of loose feedstock material to form a loose charcoal material, at 112. The method 110 can further comprise densifying the mass of loose charcoal material to form a charcoal briquette, at 113. The method 110 can further comprise disposing a combustible coating about at least a portion of the charcoal briquette, at 114.

Some or all of the elements of the method 110 can be carried out by or controlled by a computing device, such as computing device 60. For example, the processing element 62 of the computing device 60 can, based upon instructions/program code stored in the volatile memory 64 and/or the non-volatile memory 63, cause and control operation of another component or element of a system/device, such as a robotic arm, a conveyor belt, a furnace, a mill, a grinder, a press, rollers, and/or the like. By causing and controlling operation of another component or element, the computing device 60 can cause one or more elements of the method 110 to be carried out in part or in full. In some embodiments, the computing device 60 can comprise the other component or element for which the processing element 62 is causing and controlling operation thereof. In other embodiments, the computing device 60 can be configured to communicate with another apparatus, device, system, or the like, to cause control of the other component or element in accordance with one or more elements of the method 110, whether in part or in full.

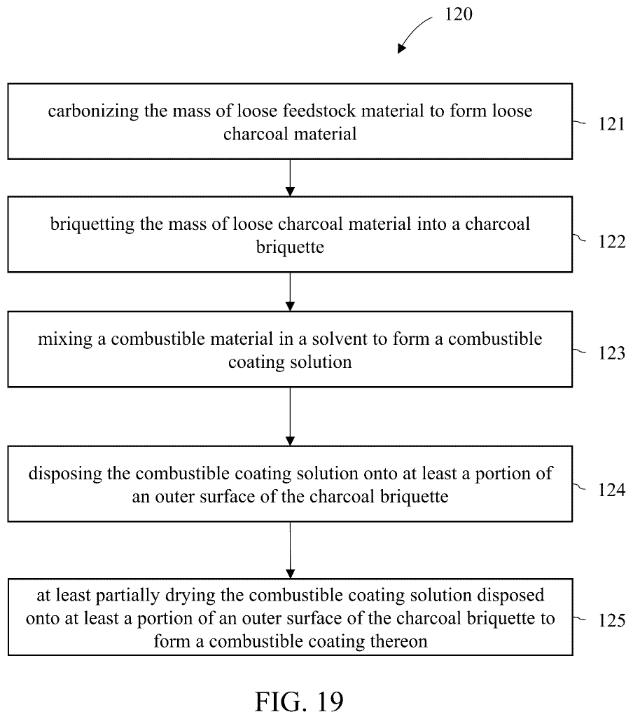

FIG. 19 illustrates a method 120 for manufacturing enhanced charcoal briquettes. The method 120 can comprise carbonizing the mass of loose feedstock material to form loose charcoal material, at 121. The method 120 can further comprise briquetting the mass of loose charcoal material into a charcoal briquette, at 122. The method 120 can further comprise mixing a combustible material in a solvent to form a combustible coating solution, at 123. The method 120 can further comprise disposing the combustible coating solution onto at least one side of the charcoal briquette, at 124. The method 120 can further comprise at least partially drying the combustible coating solution disposed onto at least one side of the charcoal briquette to form the combustible coating, at 125.

Some or all of the elements of the method 120 can be carried out by or controlled by a computing device, such as computing device 60. For example, the processing element 62 of the computing device 60 can, based upon instructions/program code stored in the volatile memory 64 and/or the non-volatile memory 63, cause and control operation of another component or element of a system/device, such as a robotic arm, a conveyor belt, a furnace, a mill, a grinder, a press, rollers, and/or the like. By causing and controlling operation of another component or element, the computing device 60 can cause one or more elements of the method 120 to be carried out in part or in full. In some embodiments, the computing device 60 can comprise the other component or element for which the processing element 62 is causing and controlling operation thereof. In other embodiments, the computing device 60 can be configured to communicate with another apparatus, device, system, or the like, to cause control of the other component or element in accordance with one or more elements of the method 120, whether in part or in full.

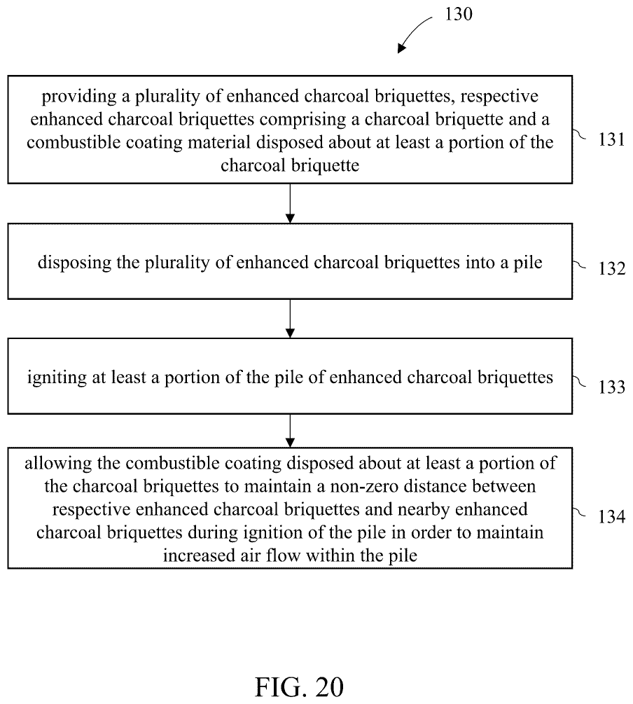

FIG. 20 illustrates a method 130 for using enhanced charcoal briquettes. The method 130 can comprise providing a plurality of enhanced charcoal briquettes, respective enhanced charcoal briquettes comprising a charcoal briquette and a combustible coating material disposed about at least a portion of the charcoal briquette, at 131. The method 130 can further comprise disposing the plurality of enhanced charcoal briquettes into a pile, at 132. The method 130 can further comprise igniting at least a portion of the pile of enhanced charcoal briquettes, at 133. The method 130 can further comprise allowing the combustible coating disposed about at least a portion of the charcoal briquettes to maintain a non-zero distance between respective enhanced charcoal briquettes and nearby enhanced charcoal briquettes during ignition of the pile in order to maintain increased air flow within the pile, at 134.

Some or all of the elements of the method 130 can be carried out by or controlled by a computing device, such as computing device 60. For example, the processing element 62 of the computing device 60 can, based upon instructions/program code stored in the volatile memory 64 and/or the non-volatile memory 63, cause and control operation of another component or element of a system/device, such as a robotic arm, a conveyor belt, a furnace, a mill, a grinder, a press, rollers, and/or the like. By causing and controlling operation of another component or element, the computing device 60 can cause one or more elements of the method 130 to be carried out in part or in full. In some embodiments, the computing device 60 can comprise the other component or element for which the processing element 62 is causing and controlling operation thereof. In other embodiments, the computing device 60 can be configured to communicate with another apparatus, device, system, or the like, to cause control of the other component or element in accordance with one or more elements of the method 130, whether in part or in full.

According to other aspects and embodiments, a fuel briquette can be provided that comprises: a compressed fuel material; and a coating disposed about at least a portion of the compressed fuel material, wherein the coating is selected from the group consisting of a primary ignition material and a combustion material. In some embodiments, the coating comprises a primary ignition material selected from the group consisting of paraffin wax, sawdust, and petroleum jelly. In some embodiments, the coating comprises a combustion material selected from the group consisting of magnesium powder, aluminum powder, and potassium nitrate. In some embodiments, the compressed fuel material comprises a biomass material selected from the group consisting of wood chips, sawdust, and agricultural waste. In some embodiments, the compressed fuel material comprises a coal-based material selected from the group consisting of lignite, bituminous coal, and anthracite. In some embodiments, the coating comprises a non-combustible material selected from the group consisting of ceramic powder, silica gel, and clay. In some embodiments, the coating comprises a less combustible material selected from the group consisting of sand, vermiculite, and perlite. In some embodiments, the coating allows for increased oxygen flow through a pile of the fuel briquettes to reduce an ignition phase of the pile and lengthen a burn phase of the pile.

According to other aspects and embodiments, an enhanced charcoal briquette can be provided that comprises: a briquette comprising a compressed combustible material; and a coating disposed about at least a portion of the briquette, wherein the coating is coupled to an outer surface of the briquette at a plurality of locations, the plurality of locations being dispersed across an area of the outer surface of the briquette such that portions of the coating are spaced a non-zero distance from the outer surface of the briquette, and wherein, in an instance in which the enhanced charcoal briquette is ignited for combustion, the non-zero distance between the portions of the coating and the outer surface of the briquette allows for increased oxygen about the briquette when the enhanced charcoal briquette is ignited for combustion. In some embodiments, the coating comprises a combustible material. In some embodiments, the coating comprises a material that is less combustible or less ignitable than the compressed combustible material. In some embodiments, the coating comprises a mixture of combustible and non-combustible materials. In some embodiments, the coating comprises a hydrophobic material to enhance water resistance. In some embodiments, the coating comprises an insulating material to improve heat retention during combustion. In some embodiments, the coating comprises a flavoring agent to impart flavor to food cooked using the briquette. In some embodiments, the coating further comprises a colorant to enhance aesthetics. In some embodiments, the coating comprises a material that emits a pleasant aroma during combustion. In some embodiments, the coating comprises a material that reduces smoke emission during combustion. In some embodiments, the coating comprises a material that increases the burning time of the briquette. In some embodiments, the coating comprises a material that reduces ash production during combustion. In some embodiments, the compressed combustible material comprises one or more of: charcoal, biomass, torrefied biomass, pyrolyzed biomass, dried biomass, bone-dry biomass, compacted biomass, pelletized biomass, extruded biomass, biomass toroidals, pressed biomass, coal, coal dust, municipal solid waste, agricultural waste, grasses, kraft pulp, paper, or recycled paper. In some embodiments, the coating comprises one or more of: a mineral, a ceramic, a compressed paper material, a stone material, a polymeric material, a cross-linked material, or a fuel additive.

According to some other aspects and embodiments, an enhanced charcoal briquette can be provided that comprises: a briquette comprising a compressed combustible material; and a coating disposed about at least a portion of the briquette. In some embodiments, the coating is coupled to an outer surface of the briquette at a plurality of locations, the plurality of locations being dispersed across an area of the outer surface of the briquette such that portions of the coating are spaced a non-zero distance from the outer surface of the briquette. In some embodiments, in an instance in which the enhanced charcoal briquette is ignited for combustion, the non-zero distance between the portions of the coating and the outer surface of the briquette allows for increased oxygen about the briquette when the enhanced charcoal briquette is ignited for combustion. In some embodiments, the coating comprises a combustible material. In some embodiments, the coating comprises a material that is less combustible or less ignitable than the compressed combustible material. In some embodiments, the compressed combustible material comprises one or more of: charcoal, biomass, torrefied biomass, pyrolyzed biomass, dried biomass, bone-dry biomass, compacted biomass, pelletized biomass, extruded biomass, biomass toroidals, pressed biomass, coal, coal dust, municipal solid waste, agricultural waste, grasses, kraft pulp, paper, or recycled paper. In some embodiments, the coating comprises one or more of: a mineral, a ceramic, a compressed paper material, a stone material, a polymeric material, a cross-linked material, or a fuel additive.

According to other aspects and embodiments, a method can be carried out for manufacturing an enhanced charcoal briquette, the method comprising: preparing a solution comprising a combustible material disposed within a liquid solvent; disposing the solution onto at least a portion of an outside surface of a charcoal briquette; and drying the solution/allowing the solution to dry, thereby forming a combustible coating covering at least a portion of the outside surface of the charcoal briquette.

In some embodiments, the charcoal briquette has a first average combustion temperature and a first average energy density, and wherein the combustible coating has a second average combustion temperature less than the first average combustion temperature and a second average energy density less than the first average energy density. In some embodiments, the first average combustion temperature is between about 700° C. and about 1,300° C. In some embodiments, the second average combustion temperature is between about 200° C. and about 250° C. In some embodiments, the first average energy density is between about 20 GJ/tonne lower heating value and about 25 GJ/tonne lower heating value. In some embodiments, the second average energy density is between about 12 GJ/m³ lower heating value and about 18 GJ/m³ lower heating value. In some embodiments, the combustible coating comprises a paper material. In some embodiments, the charcoal briquette is torrefied or carbonized. In some embodiments, a moisture content of the charcoal briquette is less than about 20 wt. %.

According to other aspects and embodiments, a method can be carried out for manufacturing an enhanced charcoal briquette, the method comprising: providing a sheet of a combustible material; contacting a portion of the sheet of the combustible material to at least a portion of an outer surface of a charcoal briquette; and separating the portion of the sheet of the combustible material from a remainder of the sheet of the combustible material, the portion of the sheet remaining at least partially in contact with at least a portion of the outer surface of the charcoal briquette, thereby forming the enhanced charcoal briquette.

In some embodiments, the charcoal briquette has a first average combustion temperature and a first average energy density, and wherein the combustible coating has a second average combustion temperature less than the first average combustion temperature and a second average energy density less than the first average energy density. In some embodiments, the first average combustion temperature is between about 700° C. and about 1,300° C. In some embodiments, the second average combustion temperature is between about 200° C. and about 250° C. In some embodiments, the first average energy density is between about 20 GJ/tonne lower heating value and about 25 GJ/tonne lower heating value. In some embodiments, the second average energy density is between about 12 GJ/m³ lower heating value and about 18 GJ/m³ lower heating value. In some embodiments, the combustible coating comprises a paper material. In some embodiments, the charcoal briquette is torrefied or carbonized. In some embodiments, a moisture content of the charcoal briquette is less than about 20 wt. %.

According to other aspects and embodiments, an enhanced charcoal briquette can comprise: a charcoal briquette comprising a mass of densified feedstock material shaped into a briquette having two or more convex surfaces, the charcoal briquette having a first average combustion temperature and a first average energy density; and a combustible coating disposed about at least a portion of the charcoal briquette, the combustible coating having a second average combustion temperature less than the first average combustion temperature and a second average energy density less than the first average energy density.

In some embodiments, the first average combustion temperature is between about 700° C. and about 1,300° C. In some embodiments, the second average combustion temperature is between about 200° C. and about 250° C. In some embodiments, the first average energy density is between about 20 GJ/tonne lower heating value and about 25 GJ/tonne lower heating value. In some embodiments, the second average energy density is between about 12 GJ/m³ lower heating value and about 18 GJ/m³ lower heating value. In some embodiments, the combustible coating comprises a paper material. In some embodiments, the charcoal briquette is torrefied. In some embodiments, a moisture content of the charcoal briquette is less than about 20 wt. %. In some embodiments, the charcoal briquette is one of: a charcoal briquette, a pellet, a peat briquette, a biomass briquette, a wood charcoal briquette, a lignite coal briquette, an anthracite coal briquette, a starch briquette, a paper briquette, a sawdust briquette, a wood briquette, a mixed solid waste briquette, a cardboard briquette, a culm bomb, a phurnacite briquette, a quick grill briquette, a ycontan, a mametan, an ogatan, a high calo tan, a tadon, or a shichirin.

According to other aspects and embodiments, a method can be carried out that comprises: providing a briquette comprising a biomass material; and disposing a combustible coating about at least a portion of the briquette. In some embodiments, the method can further comprise: heating a mass of loose feedstock in a controlled atmosphere to form a charcoal material; causing the charcoal material to be communicated into an inner volume of a briquetting device; and causing the briquetting device to densify the charcoal material to form the briquette. In some embodiments, the method can further comprise: causing a mass of loose feedstock to be communicated into an inner volume of a briquetting device; causing the briquetting device to densify the mass of loose feedstock to form the briquette; and heating the briquette in a controlled atmosphere to form a charcoal briquette. In some embodiments, the method can further comprise: applying an adhesive to at least a portion of an inner surface of the combustible coating. In some embodiments, the method can further comprise: mixing a combustible material in a solvent to form a combustible coating solution; and disposing the combustible coating solution onto at least one side of the charcoal briquette. In some embodiments, the method can further comprise: at least partially drying the combustible coating solution disposed onto at least one side of the charcoal briquette to form the combustible coating. In some embodiments, densifying the mass of biomass feedstock to form the charcoal briquette further comprises: densifying the mass of biomass feedstock to form a green briquette; and torrefying the green briquette to form the charcoal briquette. In some embodiments, the method can further comprise: mechanically separating the mass of biomass feedstock; and drying the mass of biomass feedstock.

According to other embodiments or aspects, an apparatus can be provided that comprises: at least one processor; and at least one memory storing instructions thereon that, when executed by the at least one processor, cause the apparatus to perform at least: providing a briquette comprising a biomass material; and disposing a combustible coating about at least a portion of the briquette. In some embodiments, the instructions stored on the at least one memory, when executed by the at least one processor, further cause the apparatus to perform at least: heating a mass of loose feedstock in a controlled atmosphere to form a charcoal material; causing the charcoal material to be communicated into an inner volume of a briquetting device; and causing the briquetting device to densify the charcoal material to form the briquette. In some embodiments, the instructions stored on the at least one memory, when executed by the at least one processor, further cause the apparatus to perform at least: causing a mass of loose feedstock to be communicated into an inner volume of a briquetting device; causing the briquetting device to densify the mass of loose feedstock to form the briquette; and heating the briquette in a controlled atmosphere to form a charcoal briquette. In some embodiments, the instructions stored on the at least one memory, when executed by the at least one processor, further cause the apparatus to perform at least: applying an adhesive to at least a portion of an inner surface of the combustible coating. In some embodiments, the instructions stored on the at least one memory, when executed by the at least one processor, further cause the apparatus to perform at least: mixing a combustible material in a solvent to form a combustible coating solution; and disposing the combustible coating solution onto at least one side of the charcoal briquette. In some embodiments, the instructions stored on the at least one memory, when executed by the at least one processor, further cause the apparatus to perform at least: at least partially drying the combustible coating solution disposed onto at least one side of the charcoal briquette to form the combustible coating. In some embodiments, densifying the mass of biomass feedstock to form the charcoal briquette further comprises: densifying the mass of biomass feedstock to form a green briquette; and torrefying the green briquette to form the charcoal briquette. In some embodiments, the instructions stored on the at least one memory, when executed by the at least one processor, further cause the apparatus to perform at least: mechanically separating the mass of biomass feedstock; and drying the mass of biomass feedstock.

According to other aspects or embodiments, an apparatus can be provided that comprises: at least one processor; and at least one memory storing instructions thereon that, when executed by the at least one processor, cause the apparatus to perform at least: preparing a solution comprising a combustible material disposed within a liquid solvent; disposing the solution onto at least a portion of an outside surface of a charcoal briquette; and drying the solution/allowing the solution to dry, thereby forming a combustible coating covering at least a portion of the outside surface of the charcoal briquette. In some embodiments, the charcoal briquette has a first average combustion temperature and a first average energy density, and wherein the combustible coating has a second average combustion temperature less than the first average combustion temperature and a second average energy density less than the first average energy density. In some embodiments, the first average combustion temperature is between about 700° C. and about 1,300° C. In some embodiments, the second average combustion temperature is between about 200° C. and about 250° C. In some embodiments, the first average energy density is between about 20 GJ/tonne lower heating value and about 25 GJ/tonne lower heating value. In some embodiments, the second average energy density is between about 12 GJ/m³ lower heating value and about 18 GJ/m³ lower heating value. In some embodiments, the combustible coating comprises a paper material. In some embodiments, the charcoal briquette is torrefied or carbonized. In some embodiments, a moisture content of the charcoal briquette is less than about 20 wt. %.

According to other aspects or embodiments, an apparatus can be provided that comprises: at least one processor; and at least one memory storing instructions thereon that, when executed by the at least one processor, cause the apparatus to perform at least: providing a sheet of a combustible material; contacting a portion of the sheet of the combustible material to at least a portion of an outer surface of a charcoal briquette; and separating the portion of the sheet of the combustible material from a remainder of the sheet of the combustible material, the portion of the sheet remaining at least partially in contact with at least a portion of the outer surface of the charcoal briquette, thereby forming the enhanced charcoal briquette. In some embodiments, the charcoal briquette has a first average combustion temperature and a first average energy density, and wherein the combustible coating has a second average combustion temperature less than the first average combustion temperature and a second average energy density less than the first average energy density. In some embodiments, the first average combustion temperature is between about 700° C. and about 1,300° C. In some embodiments, the second average combustion temperature is between about 200° C. and about 250° C. In some embodiments, the first average energy density is between about 20 GJ/tonne lower heating value and about 25 GJ/tonne lower heating value. In some embodiments, the second average energy density is between about 12 GJ/m³ lower heating value and about 18 GJ/m³ lower heating value. In some embodiments, the combustible coating comprises a paper material. In some embodiments, the charcoal briquette is torrefied or carbonized. In some embodiments, a moisture content of the charcoal briquette is less than about 20 wt. %.

According to other aspects and embodiments, a device for manufacturing enhanced fuel briquettes can be provided, the device comprising: a densification unit configured to receive a mass of loose feedstock material and densify the mass of loose feedstock material into a briquette;

an adhesive applicator configured to dispose a volume of an adhesive to at least a portion of an outer surface of the briquette; and a coating applicator configured to dispose a coating comprising a combustible material onto at least the portion of the outer surface of the briquette to which the adhesive applicator disposed the volume of the adhesive.

According to other aspects and embodiments, a charcoal briquette can be provided, formed, manufactured, stored, used, or transported. The charcoal briquette can comprise: a charcoal core; and a primary combustion/ignition material disposed about a portion of the charcoal core. In some embodiments, the primary combustion/ignition material is applied as a coating on an outer surface of the charcoal core. In some embodiments, the primary combustion/ignition material is interspersed within the charcoal core. In some embodiments, the charcoal briquette can further comprise: a protective layer covering the primary combustion/ignition material. In some embodiments, the protective layer is heat-resistant and prevents premature ignition of the primary combustion/ignition material. In some embodiments, the primary combustion/ignition material comprises a mixture of at least one accelerant and a binder. In some embodiments, the accelerant is selected from the group consisting of potassium nitrate, sodium nitrate, and charcoal lighter fluid. In some embodiments, the binder is selected from the group consisting of starch, clay, and vegetable oil.

According to other aspects and embodiments, a method for manufacturing a charcoal briquette can be carried out, the method comprising: providing a charcoal core; and applying a primary combustion/ignition material about at least a portion of the charcoal core. In some embodiments, the method can further comprise: curing the charcoal briquette to enhance the adherence of the primary combustion/ignition material to the charcoal core. In some embodiments, applying the primary combustion/ignition material further comprises spraying, dipping, or coating the charcoal core with the primary combustion/ignition material.

According to other aspects and embodiments, a charcoal briquette system can be provided or used, the charcoal briquette system comprising a plurality of charcoal briquettes, each charcoal briquette comprising: a charcoal core; and a primary combustion/ignition material disposed about a portion of the charcoal core. In some embodiments, the primary combustion/ignition material on each briquette is tailored to provide consistent and controlled ignition characteristics. In some embodiments, the primary combustion/ignition material on each briquette is configured to enable quick and efficient lighting of the charcoal core.

According to other aspects and embodiments, a charcoal briquette can be provided, manufactured, stored, or used, the charcoal briquette comprising: a charcoal core; and a primary combustion/ignition material applied as a coating on at least a portion of an outer surface of the charcoal core, said primary combustion/ignition material comprising a mixture of an accelerant material and a binder material. In some embodiments, a ratio of the accelerant material to the binder material in the primary combustion/ignition material is optimized to achieve a desired ignition temperature within a range of about 350° C. to about 450° C. In some embodiments, the accelerant material comprises a paper material. In some embodiments, the binder material comprises a starch. In some embodiments, the method further comprises: an adhesive material disposed between at least a portion of the outer surface of the charcoal core and at least a portion of the primary combustion/ignition material. In some embodiments, the adhesive comprises one of: a vegetable oil, a starch, a clay, a gelatin, a binder polymer, a polyvinyl alcohol, a polyvinyl acetate, a cellulose-based adhesive, an epoxy, a resin, a glycerol, a pectin, a protein-based adhesive, a casein-containing material, a soy protein-containing material, a modified acrylic material, a silicon-based adhesive, an epoxy resin, or a solvent-based adhesive.

From the foregoing, it will be seen that aspects herein are well adapted to attain all the ends and objects hereinabove set forth together with other advantages which are obvious and which are inherent to the structure.

It will be understood that certain features and sub-combinations are of utility and may be employed without reference to other features and sub-combinations. This is contemplated by and is within the scope of the claims.

Since many possible aspects may be made without departing from the scope thereof, it is to be understood that all matter herein set forth or shown in the accompanying drawings is to be interpreted as illustrative and not in a limiting sense.

Various modifications and variations can be made to the compounds, compositions and methods described herein. Other aspects of the compounds, compositions and methods described herein will be apparent from consideration of the specification and practice of the compounds, compositions and methods disclosed herein. It is intended that the specification and examples be considered as exemplary.

1.-8. (canceled)

9. An enhanced charcoal briquette comprising:
a briquette comprising a compressed combustible material; and
a coating disposed about at least a portion of the briquette,
wherein the coating is coupled to an outer surface of the briquette at a plurality of locations, the plurality of locations being dispersed across an area of the outer surface of the briquette such that portions of the coating are spaced a non-zero distance from the outer surface of the briquette, and
wherein, in an instance in which the enhanced charcoal briquette is ignited for combustion, the non-zero distance between the portions of the coating and the outer surface of the briquette allows for increased oxygen about the briquette when the enhanced charcoal briquette is ignited for combustion.

10. The enhanced charcoal briquette of claim 9, wherein the coating comprises a combustible material.

11. The enhanced charcoal briquette of claim 9, wherein the coating comprises a material that is less combustible or less ignitable than the compressed combustible material.

12. The enhanced charcoal briquette of claim 9, wherein the coating comprises a mixture of combustible and non-combustible materials.

13. The enhanced charcoal briquette of claim 9, wherein the coating comprises a hydrophobic material to enhance water resistance.

14. The enhanced charcoal briquette of claim 9, wherein the coating comprises an insulating material to improve heat retention during combustion.

15. The enhanced charcoal briquette of claim 9, wherein the coating comprises a flavoring agent to impart flavor to food cooked using the briquette.

16. The enhanced charcoal briquette of claim 9, wherein the coating further comprises a colorant to enhance aesthetics.

17. The enhanced charcoal briquette of claim 9, wherein the coating comprises a material that emits a pleasant aroma during combustion.

18. The enhanced charcoal briquette of claim 9, wherein the coating comprises a material that reduces smoke emission during combustion.

19. The enhanced charcoal briquette of claim 9, wherein the coating comprises a material that increases the burning time of the briquette.

20. The enhanced charcoal briquette of claim 9, wherein the coating comprises a material that reduces ash production during combustion.

21. The enhanced charcoal briquette of claim 9, wherein the compressed combustible material comprises one or more of: charcoal, biomass, torrefied biomass, pyrolyzed biomass, dried biomass, bone-dry biomass, compacted biomass, pelletized biomass, extruded biomass, biomass toroidals, pressed biomass, coal, coal dust, municipal solid waste, agricultural waste, grasses, kraft pulp, paper, or recycled paper.

22. The enhanced charcoal briquette of claim 9, wherein the coating comprises one or more of: a mineral, a ceramic, a compressed paper material, a stone material, a polymeric material, a cross-linked material, or a fuel additive.

23. A method of manufacturing an enhanced charcoal briquette, the method comprising:
preparing a solution comprising a combustible material disposed within a liquid solvent;
disposing the solution onto at least a portion of an outside surface of a charcoal briquette; and
drying the solution/allowing the solution to dry, thereby forming a combustible coating covering at least a portion of the outside surface of the charcoal briquette.

24. The method of claim 23, wherein the charcoal briquette has a first average combustion temperature and a first average energy density, and wherein the combustible coating has a second average combustion temperature less than the first average combustion temperature and a second average energy density less than the first average energy density.

25. The method of claim 23, wherein the first average combustion temperature is between about 700° C. and about 1,300° C. and the second average combustion temperature is between about 200° C. and about 250° C.

26. (canceled)

27. The method of claim 23, wherein the first average energy density is between about 20 GJ/tonne lower heating value and about 25 GJ/tonne lower heating value and the second average energy density is between about 12 GJ/m³ lower heating value and about 18 GJ/m³ lower heating value.

28.-40. (canceled)

41. An enhanced charcoal briquette comprising:
a charcoal briquette comprising a mass of densified feedstock material shaped into a briquette having two or more convex surfaces, the charcoal briquette having a first average combustion temperature and a first average energy density; and
a combustible coating disposed about at least a portion of the charcoal briquette, the combustible coating having a second average combustion temperature less than the first average combustion temperature and a second average energy density less than the first average energy density.

42-104. (canceled)
